(19) United States
(12) Patent Application Publication
(10) Pub. No.: US 2026/0319720 A1
(43) Pub. Date: Oct. 15, 2026

(54) STORAGE MEDIUM, INFORMATION PROCESSING APPARATUS, AND METHOD FOR CONTROLLING INFORMATION PROCESSING APPARATUS

(71) Applicant: CANON KABUSHIKI KAISHA, Tokyo (JP)

(72) Inventor: Masaki Yamamichi, Kanagawa (JP)

(21) Appl. No.: 19/290,742

(22) Filed: Aug. 5, 2025

(30) Foreign Application Priority Data
Aug. 23, 2024 (JP) 2024-143490

(51) Int. Cl. G06F 3/12

(52) U.S. Cl. CPC G06F 3/1228; G06F 3/1203

(57) ABSTRACT

Provided is a non-transitory computer-readable storage medium storing a program of a print application for print settings for causing an information processing apparatus to execute a method, the method including: obtaining vendor information on a printing apparatus connected to the information processing apparatus from an extension application which operates in the information processing apparatus and extends functionality of a generic printer driver operating in the information processing apparatus; and performing display control to display the printing apparatus corresponding to the vendor information as a candidate for a printing apparatus for print output.

### BACKGROUND

### Field of the Technology

The present disclosure relates to a storage medium, an information processing apparatus, and a method for controlling the information processing apparatus.

### Description of the Related Art

Generic printer drivers supporting an industry-standard protocol such as Internet Printing Protocol (IPP) have been in widespread use in recent years. A generic printer driver handles print data supported by printers provided by various vendors and therefore has limited items and functions that are settable as print settings. At the same time, the functionality of a print application that enables configuration of print settings and uses such a generic printer driver is also limited.

Literature 1 (Japanese Patent Laid-Open No. 2021-124791) discloses a method for extending the functionality of a generic printer driver and of a print application by extending a print que associated with the generic printer driver by use of identification information on a printer associated with the generic printer driver.

However, the method in Literature 1 has the following problem. Specifically, in a case where a print application limits and displays a printer for print output based on information indicative of the vendor of a printer driver, a printer provided by a particular vendor may fail to be displayed properly.

### SUMMARY

A non-transitory computer-readable storage medium storing a program of a print application for print settings for causing an information processing apparatus to execute a method, the method having: obtaining vendor information on a printing apparatus connected to the information processing apparatus from an extension application which operates in the information processing apparatus and extends functionality of a generic printer driver operating in the information processing apparatus; and performing display control to display the printing apparatus corresponding to the vendor information as a candidate for a printing apparatus for print output.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example configuration of a printing system;

FIGS. 2A to 2E are block diagrams showing example hardware configurations of apparatuses constituting the printing system;

FIG. 3 is a diagram showing the relationship of FIGS. 3A and 3B; FIG. 3A is a sequence diagram showing example processing for installing a print settings extension app; FIG. 3B is a sequence diagram showing example processing for installing a print settings extension app;

FIG. 4 is a diagram showing an example of capability information;

FIG. 5 is a diagram showing an example screen displayed on a client terminal;

FIG. 6 is a diagram showing the relationship of FIGS. 6A and 6B; FIG. 6A is a diagram showing an example of device capability information; FIG. 6B is a diagram showing an example of device capability information;

FIG. 7 is a diagram showing the relationship of FIGS. 7A and 7B; FIG. 7A is a diagram showing an example of device capability information; FIG. 7B is a diagram showing an example of device capability information;

FIG. 8 is a diagram showing the relationship of FIGS. 8A to 8C; FIG. 8A is a diagram showing an example of device capability information; FIG. 8B is a diagram showing an example of device capability information; FIG. 8C is a diagram showing an example of device capability information;

FIG. 9 is a diagram showing an example of content of an extension setup information file;

FIG. 10 is a sequence diagram showing an example of display processing where a print app displays a printer provided by a particular vendor as a printer for print output;

FIG. 11 is a diagram showing an example screen displayed by the print app;

FIG. 12 is a flowchart showing an example of display determination processing executed by the print app;

FIG. 13 is a diagram showing an example configuration of the printing system and an example software configuration of the printing system;

FIG. 14 is a flowchart showing an example of display determination processing executed by the print app;

FIG. 15 is a flowchart showing an example of display determination processing executed by the print app; and

FIG. 16 is a flowchart showing an example of display determination processing executed by the print app.

### DESCRIPTION OF THE EMBODIMENTS

Preferred embodiments of the present disclosure are described in detail below with reference to the drawings attached hereto. Note that the embodiments below are not provided to limit the matters disclosed herein, and also, not all the combinations of features described in the embodiments below are necessarily essential as solutions provided by the present disclosure. Note that the same configurations are described using the same reference sign.

A generic printer driver is a general-purpose printer driver different from a vendor-specific printer driver provided by a vendor of a printer. Generic printer drivers include a local printer driver that transmits print data directly to a printer or a cloud printer driver that transmits print data to a cloud printer service.

A generic printer driver can communicate with each of the printers provided by a plurality of printer vendors. Thus, by using a generic printer driver, a user can transmit print data to an image formation apparatus (a printer) or a cloud print service without having to install a vendor-specific printer driver into a client terminal. A generic printer driver handles print data supported by printers provided by various printer vendors and therefore has limited items and functions that are settable as print settings.

There is a print application used to configure print settings and the like by obtaining a printer's capability information to be described later via a printer driver. In a case where a generic printer driver is used, a printer's capability information which a print application can obtain via the generic printer driver is similarly limited, which consequently limits items and functions that the printer application can configure as print settings.

A print application which obtains a printer's capability information via a generic printer driver with extended functionality as described earlier and configures print-related setting items and the like provides functions of a standard printer as well as functions specific to a printer vendor.

A print application using a generic printer driver having similar functions to a vendor-specific printer driver may, in order to ensure quality, limit a printer for print output to a particular vendor of a printer driver.

However, a generic printer driver is typically provided by the vendor of the operating system (OS), and in this case, the vendor of the generic printer driver is the provider of the OS. This hinders the print application from limiting and displaying a printer for print output based on information indicative of a particular vendor of a printer driver.

The embodiments given below describe details of a method in which a print application displays a printer provided by a particular vendor as a printer for print output.

### First Embodiment

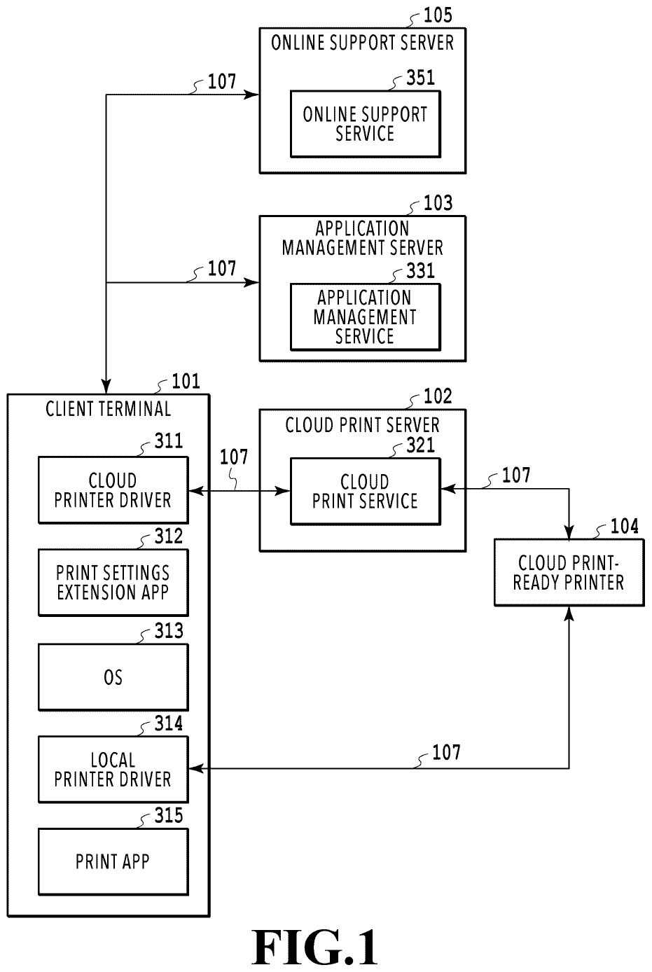

An embodiment for carrying out the present disclosure is described below with reference to the drawings. FIG. 1 is a diagram showing an example configuration of a printing system of the present embodiment and example software configurations of apparatuses included in the system.

The printing system has a client terminal 101, a cloud print server 102, an application management server 103, a cloud print-ready printer 104, and an online support server 105.

The client terminal 101 is communicatively connected to the cloud print server 102, the application management server 103, the cloud print-ready printer 104, and the online support server 105 via a network 107. The cloud print-ready printer 104 is communicatively connected to the cloud print server 102 via the network 107.

Although FIG. 1 shows an example where there are a single client terminal 101 and a single cloud print-ready printer 104, they may be two or more of each.

Also, the cloud print server 102, the application management server 103, and the online support server 105 may each be a server system formed by a plurality of information processing apparatuses. By being a server system formed by a plurality of information processing apparatuses, each server can distribute its load among the plurality of information processing apparatuses.

Also, the cloud print server 102, the application management server 103, and the online support server 105 may be virtually implemented inside a single physical information processing apparatus.

Although a wide area network (WAN), such as the Internet, which enables connection to a cloud service, is assumed here as the network 107, the network 107 may be implemented as a closed environment formed entirely by, e.g., an in-house local area network (LAN).

The client terminal 101 is an information processing apparatus such as a personal computer (PC), a tablet terminal, or a smartphone, and is directly operated by a user.

Any application software can be executed on the client terminal.

The client terminal 101 has an operating system (OS) 313 as basic software, a cloud printer driver 311 to be described later, a print settings extension application (app) 312, a local printer driver 314, and a print app 315.

The print settings extension app 312 is an extension application for extending the functionality of the cloud printer driver 311 and includes a capability information obtainment component 3121, a capability information update component 3122, and a capability information provision component 3123 (not shown).

The capability information obtainment component 3121 obtains device capability information to be described later directly from a cloud print service 321 or the cloud print-ready printer 104. The capability information obtainment component 3121 can also obtain the device capability information from the cloud print service 321 or the cloud print-ready printer 104 via the OS 313.

The capability information update component 3122 updates device capability information stored in a directory referred to by the OS 313. The capability information provision component 3123 provides the print app 315 with the updated device capability information via the OS 313. Besides these components, the print settings extension app 312 may include other components such as a display control component configured to display a settings screen.

The print app 315 is an application used for configuration of print settings and includes a printer information obtainment component 3151, a capability information analysis component 3152, and a display control component 3153 (not shown).

The printer information obtainment component 3151 obtains various pieces of printer-related information from the OS 313, a generic printer driver such as the cloud printer driver 311, the cloud print service 321, and a printer such as the cloud print-ready printer 104.

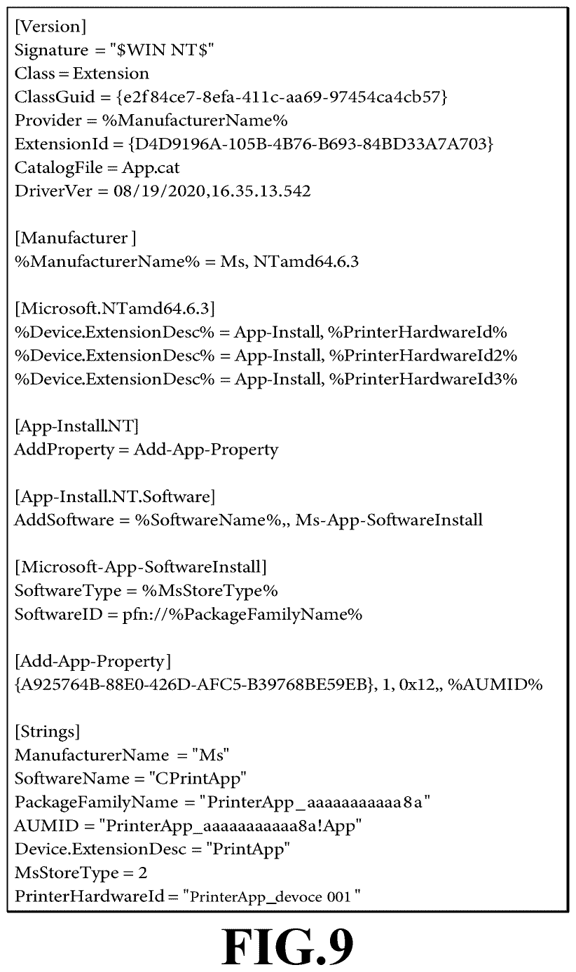

The capability information analysis component 3152 analyzes and reads device capability information and printer-related information. The display control component 3153 displays a user interface to be described later, like the one shown in FIG. 9. The print app 315 is formed by these control components, but may also include other control components such as a generation component configured to generate a print job.

The cloud print-ready printer 104 is an image formation apparatus configured to form an image on a printing medium such as a sheet of paper. The cloud print-ready printer 104 also converts print data received via the network 107 into image data and executes a printing process.

The cloud print-ready printer 104 can receive print data from the client terminal 101 via the cloud print server 102 or can receive print data not via the cloud print server 102 but directly from the client terminal 101.

The cloud print-ready printer 104 receives print data generated by the cloud printer driver 311 of the client terminal 101 via the cloud print server 102.

The cloud print-ready printer 104 can also receive print data generated by the local printer driver 314 of the client terminal 101 not via the cloud print server 102. The cloud printer driver 311 and the local printer driver 314 are both a generic printer driver provided by the vendor of the OS 313.

The cloud print server 102 is a server apparatus that provides the cloud print service 321. Provision of the cloud print service 321 means provision of a print service via the cloud print server 102. For example, the cloud print server 102 that provides the cloud print service 321 receives a print instruction, print data, and the like from the client terminal 101 or the like and transmits the received print data to the predetermined cloud print-ready printer 104.

The application management server 103 is a server apparatus that provides an application management service 331. The application management server 103 keeps and manages various applications for providing the application management service 331. The application management service 331 includes a service for providing an application in response to a download request. For example, the application management server 103 receives identification information on an application and a download request from the client terminal 101 or the like and transmits the application identified based on the received identification information to the client terminal 101.

The online support server 105 is a server apparatus that provides an online support service 351. The online support service 351 is a service for providing the client terminal 101 with an extension setup information file containing information for extending the functionality of the client terminal 101.

Hereinafter, in cases where a predetermined server apparatus provides a predetermined service, the information processing performed by the predetermined server apparatus is described with the predetermined service as the main processing entity.

This applies to the embodiments to be described later.

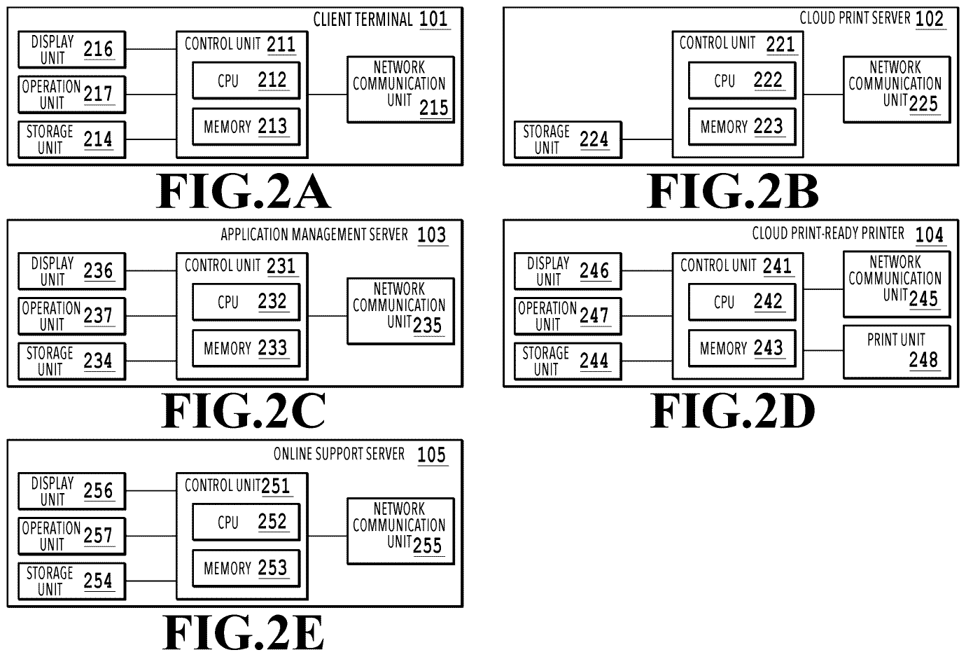

Next, the hardware configurations of the apparatuses constituting the printing system of the present embodiment are described with reference to FIGS. 2A to 2E. FIG. 2A is a block diagram showing an example hardware configuration of the client terminal 101. The client terminal 101 has a display unit 216, an operation unit 217, a storage unit 214, a control unit 211, and a network communication unit 215. The control unit 211 includes a CPU 212 and memory 213.

The storage unit 214 is a non-volatile storage device such as a hard disk or a solid-state drive (SSD), where digital data can be stored or rewritten. The storage unit 214 may be expressed as a storage.

The control unit 211 controls overall operation of the client terminal 101. The CPU 212 loads a program stored in the storage unit 214 into the memory 213 and executes the loaded program. The memory 213 is the main storage memory for the CPU 212 and is used as a workspace or a temporary storage region to load various programs.

The network communication unit 215 is a device configured to communicate with an external apparatus via the network 107. For example, via the network 107, the network communication unit 215 can receive digital data from an external server, the client terminal, or the like and can transmit digital data to these apparatuses.

The display unit 216 is a device such as a liquid crystal display and displays visual information to a user. The operation unit 217 is a device for receiving a user input through a keyboard, a mouse, or the like. Note that a device including the functionality of both of the display unit 216 and the operation unit 217, like a touch panel or the like, may be used for the client terminal 101. The client terminal 101 may have a typical web browsing function.

FIG. 2B is a block diagram showing an example hardware configuration of the cloud print server 102. The cloud print server 102 has a storage unit 224, a control unit 221, and a network communication unit 225. The control unit 221 includes a CPU 222 and memory 223.

The storage unit 224, the control unit 221, and the network communication unit 225 are similar to the storage unit 214, the control unit 211, and the network communication unit 215, respectively, and are therefore not described here.

Although formed by a single information apparatus having the hardware configuration shown in FIG. 2B in the example described herein, the cloud print server 102 may be formed by a plurality of information processing apparatuses.

FIG. 2C is a block diagram showing an example hardware configuration of the application management server 103. The application management server 103 has a display unit 236, an operation unit 237, a storage unit 234, a control unit 231, and a network communication unit 235. The control unit 231 includes a CPU 232 and memory 233.

The display unit 236, the operation unit 237, the storage unit 234, the control unit 231, and the network communication unit 235 are similar to the display unit 216, the operation unit 217, the storage unit 214, the control unit 211, and the network communication unit 215, respectively, and are therefore not described here.

Although formed by a single information apparatus having the hardware configuration shown in FIG. 2C in the example described herein, the application management server 103 may be formed by a plurality of information processing apparatuses.

FIG. 2D is a block diagram showing an example hardware configuration of the cloud print-ready printer 104. The cloud print-ready printer 104 has a display unit 246, an operation unit 247, a storage unit 244, a control unit 241, a network communication unit 245, and a print unit 248. The control unit 241 includes a CPU 242 and memory 243.

The display unit 246 is a touch panel or a light emitting diode (LED) display provided to the cloud print-ready printer 104 and is a device for displaying information to a user.

The operation unit 247 is a device for receiving a user input. The operation unit 247 may include hardware keys such as numeric keys and a power button for powering on the cloud print-ready printer 104. The operation unit 247 may also include software keys displayed on a touch panel or the like. The storage unit 244 and the control unit 241 are similar to the storage unit 214 and the control unit 211, respectively, and are therefore not described here.

The network communication unit 245 is a device configured to communicate with an external apparatus via the network 107. The network communication unit 245 can mainly receive print data and transmit, to an external server or the like, information indicating the status of the cloud print-ready printer 104, such as an error.

The print unit 248 is a device configured to perform a printing process on a printing medium supplied to a paper feed unit such as a cassette or a tray by performing a series of operations thereon, such as conveyance, printing, and discharge. A printing method that can be employed by the cloud print-ready printer 104 of the present embodiment includes, but is not limited to, the electrophotographic method, the inkjet method, and the like. The print unit 248 also includes a duplex unit used in executing a duplex printing process and a finishing device such as a stapler or a puncher used in a punching process.

Although described as being a single-function printer with a printer function in the example described herein, the cloud print-ready printer 104 of the present embodiment may be a multifunction printer (a multifunction device) having a scanner function and a facsimile function as well. Also, the cloud print-ready printer 104 may have a typical web browsing function.

FIG. 2E is a block diagram showing an example hardware configuration of the online support server 105. Although formed by a single information apparatus in the example described herein, the online support server 105 of the present embodiment may be formed by a plurality of information processing apparatuses.

The online support server 105 has a display unit 256, an operation unit 257, a storage unit 254, a control unit 251, and a network communication unit 255. The control unit 251 includes a CPU 252 and memory 253.

The display unit 256 and the operation unit 257 are similar to the display unit 216 and the operation unit 217, respectively, and are therefore not described here. The storage unit 254 is a storage device such as a hard disk drive (HDD) or an SSD. The storage unit 254 stores, e.g., an extension setup information file, which is a file containing information for extending the functionality of an application implemented in the client terminal 101.

The CPU 252 performs overall control of the online support server 105. The memory 253 is the main storage memory for the CPU 252 and is used as a workspace or a temporary storage region to load various programs.

The network communication unit 255 is an interface for the online support server 105 to communicate with the client terminal 101 and the like. Via the network communication unit 255, the online support server 105 receives an obtainment request for a file stored in the storage unit 254 and sends a file corresponding to the obtainment request back to the client terminal 101.

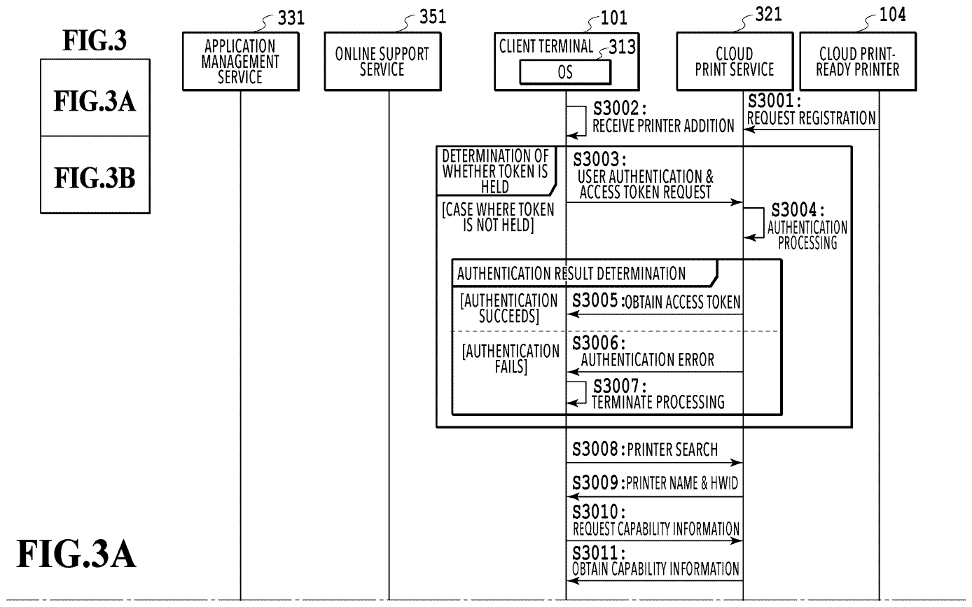

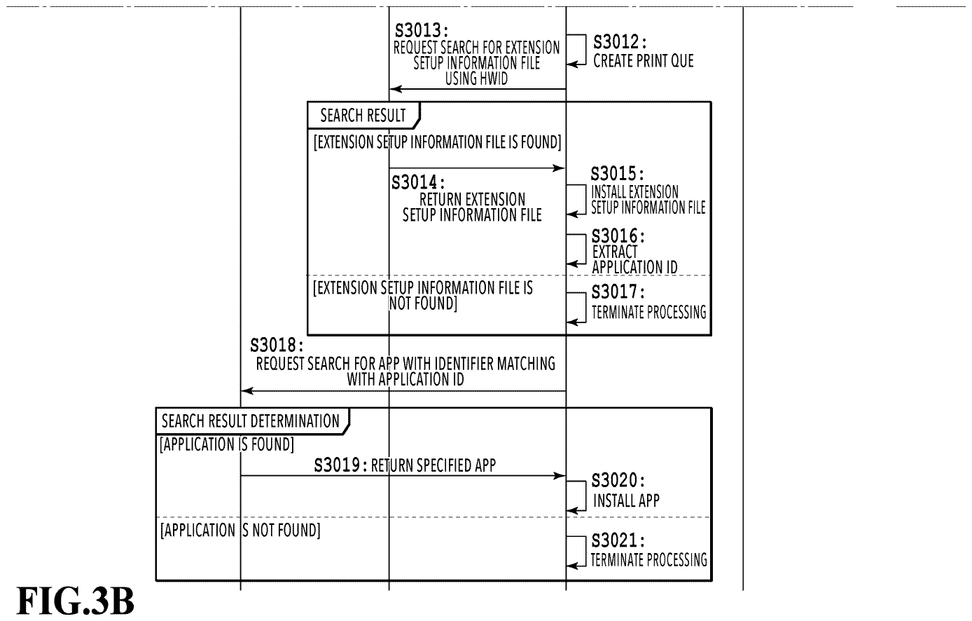

FIGS. 3A and 3B are a diagram showing an example sequence of information processing executed by the apparatuses of the printing system of the present embodiment in the event where the client terminal 101 is installed with the print settings extension app 312. User operations and the information processing performed by the apparatuses of the printing system in the present embodiment are described with reference to FIGS. 3A and 3B.

In S3001, from a user, the cloud print-ready printer 104 receives a printer registration operation for registering the cloud print-ready printer 104 to the cloud print service 321. Then, in S3001, the cloud print-ready printer 104 transmits a printer registration request along with device identification information on the printer to the cloud print service 321.

Here, the device identification information transmitted to the cloud print service 321 is, for example, a hardware ID (HWID) assigned to the printer's model. Note that the device identification information may be any type of information as long as the printer's model can be identified with it.

In S3001, upon receipt of the registration request, the cloud print service 321 transmits, to the cloud print-ready printer 104, a uniform resource locator (URL) for a cloud print server that performs printer registration processing. In accordance with a user operation performed on the URL received, the cloud print-ready printer 104 displays, on the display unit 246, an input screen used to enter a user ID and a password necessary to use the cloud print service. Alternatively, the client terminal 101 can display the input screen on the display unit 216 upon receipt of a user operation of entering the URL. Note that the present embodiment describes an example where the cloud print server that performs the printer registration processing is the cloud print server 102.

The user enters a user ID and a password on the input screen. The cloud print service 321 performs user authentication using the user ID and the password entered by the user. If the user authentication succeeds, the cloud print service 321 transmits, to the cloud print-ready printer 104, an obtainment request for printer information necessary in registering the printer. In response to the request, the cloud print-ready printer 104 transmits printer information to the cloud print service 321.

Next, upon receipt of the printer information from the cloud print-ready printer 104, the cloud print service 321 registers the printer information on the cloud print-ready printer 104 and generates a print que for the cloud print-ready printer 104. In this event, the cloud print service 321 obtains capability information on the cloud print-ready printer 104 from the cloud print-ready printer 104 and associates the capability information with the generated print que. The capability information in the present embodiment is information indicative of print functions that the printer has, and includes information necessary in the event where a user configures print settings at the time of printing, such as duplex printing capability information, color printing capability information, and stapling capability information.

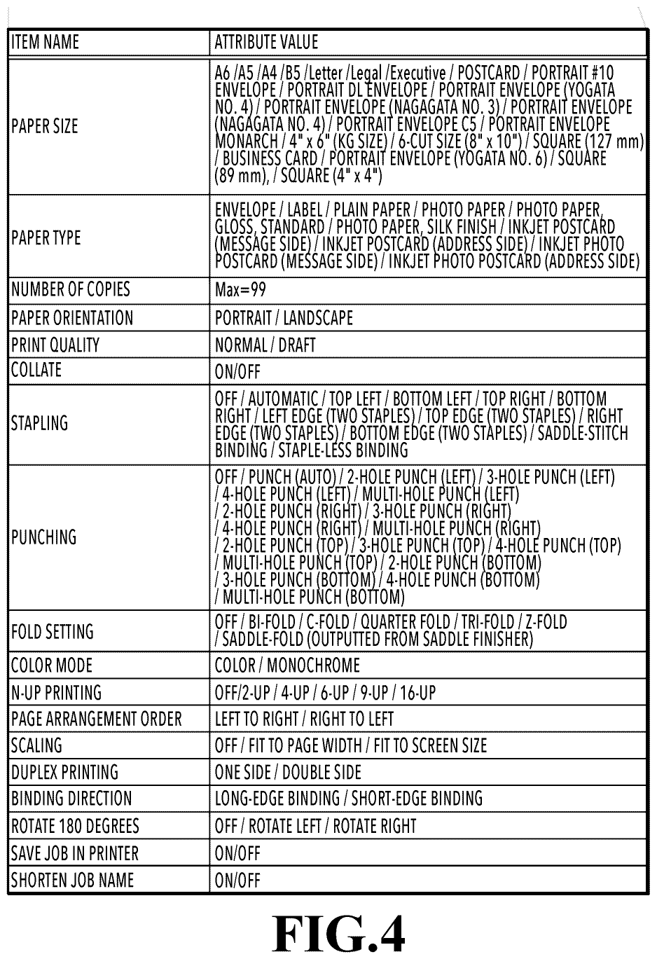

With reference to FIG. 4, capability information in the present embodiment is described. FIG. 4 is a diagram showing an example of capability information in the present embodiment. Capability information is formed by item names and attribute values. An item name indicates the name of a setting item of print settings. An attribute value indicates a set value, an option, or a range of values settable for a setting item. The cloud print-ready printer 104 holds not only item names and attribute values defined as industry-standard specifications by the Internet Printing Protocol (IPP), but also item names and attribute values defined uniquely by the vendor of the printer.

In the present embodiment, unless otherwise noted, the cloud print-ready printer 104 transmits the capability information to the cloud print service 321 following IPP as a communication protocol. Using a command prepared for registering capability information to the cloud print service 321, the user performs a registration operation for registering capability information, on the cloud print-ready printer 104.

Upon receipt of the registration operation by the user, the cloud print-ready printer 104 notifies the cloud print service 321 of the item names shown in FIG. 4, attribute values corresponding to the item names, and default values. The capability information notified of here is not limited to the item names and attribute values defined by IPP. For example, although “SAVE JOB IN PRINTER” and “STAPLE-LESS BINDING” for “STAPLER” shown in FIG. 4 are an item name and an attribute value defined uniquely by the vendor of the printer, they are given and registered to the cloud printer server.

Referring back to FIG. 3A, a description is given of processing for installing the print settings extension app 312, which is performed in the event where a user performs a setup operation on the client terminal 101 to print with the cloud print-ready printer 104.

To register the cloud print-ready printer 104 to the client terminal 101, the client terminal 101 uses a standard print function, which is one of the functions that the OS 313 has.

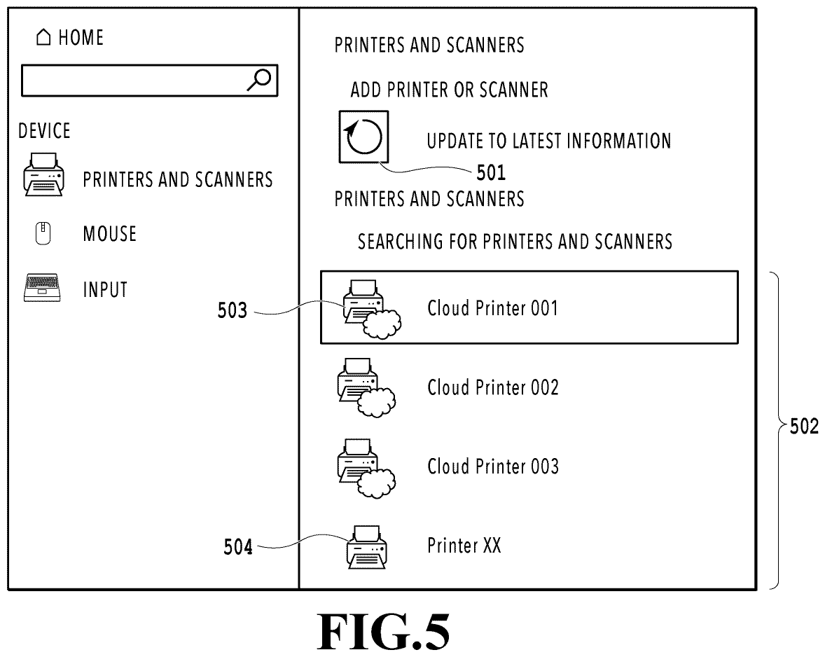

In S3002, the OS 313 receives a printer addition operation, which is included in the user's setup operation for the cloud print-ready printer 104. With reference to FIG. 5, printer addition processing is described.

FIG. 5 is a screen related to a printer to be registered to the client terminal 101, the screen being displayed on the display unit 216 by the OS 313 of the client terminal 101. Once a user selects an object 501, the OS 313 receives a printer search instruction.

Upon receipt of the printer search instruction, the OS 313 determines whether a token for using the cloud print service 321 is stored in the storage. The token is hereinafter referred to as an access token for accessing the cloud print server 102. In a case where the access token is not stored in the storage, the OS 313 displays a screen for entering user information (a login name and a password) (not shown). The user then enters user information on the screen.

In S3003, upon receipt of the user's operation of entering the user information, the OS 313 transmits the user information to the cloud print service 321, requesting for user authentication and an access token.

In S3004, the cloud print service 321 performs authentication processing using the user information received from the client terminal 101. Upon completion of the authentication processing, the cloud print service 321 notifies the client terminal 101 of the result of the authentication processing.

If the result thus notified of indicates that the user authentication succeeded, in S3005 the OS 313 obtains an access token from the cloud print service 321. If the result thus notified of indicates that the user authentication did not succeed, in S3006 the OS 313 is notified of an authentication error by the cloud print service 321.

In S3007, based on information on the authentication error received in S3006, the OS 313 terminates the installation processing. Specifically, if the OS 313 cannot obtain an access token, the OS 313 terminates the processing shown in the sequence in FIGS. 3A and 3B. If an access token is stored in the storage or if an access token is obtained in S3005, the OS 313 proceeds to S3008.

In S3008, the OS 313 searches for printers registered to the cloud print service 321 and printers connected to the network 107. For example, the OS 313 performs the printer search by transmitting an obtainment request for printer information registered to the cloud print service 321 to the cloud print service 321. In this event, the OS 313 transmits the obtainment request for printer information to the cloud print service 321 with the access token included in the request. Printer information in the present embodiment is a printer name associated with the printer registered to the cloud print service 321 in S3001 and the HWID of the printer.

In S3009, the cloud print service 321 transmits, to the client terminal 101, a list of printers that the user who is identified by the access token included in the obtainment request is permitted to use, as well as printer information corresponding to each of the printers in the list.

The OS 313 obtains the list of printers transmitted from the cloud print service 321 and device identification information included in the printer information to identify the printers. Note that in parallel with processing in S3008 and processing in S3009, the OS 313 searches for printers connected to the same network as the client terminal 101.

This is a device search based on Multicast Domain Name System (mDNS), Bonjour (registered trademark), or the like.

Based on the printer information obtained from the cloud print service 321 and the printer information on the printers connected to the same network which are detected as a result of the printer search, the OS 313 displays a list of printers on the display unit 216 of the client terminal 101. For example, the OS 313 displays a list of printers as shown in a region 502 in FIG. 5.

A list of pieces of information indicative of printers corresponding to the printer information received from the cloud print service 321 and the like is displayed in the region 502 shown in FIG. 5. Of the pieces of information on printers displayed in the region 502, “Cloud Printer 001,” “Cloud Printer 002,” and “Cloud Printer 003” are information indicative of printers registered to the cloud print service 321, and “Printer XX” is information indicative of the printer detected by the client terminal 101 as a result of searching for printers connected to the same network.

In this way, the OS 313 displays a list of information indicative of a printer corresponding to the printer information obtained from the cloud print service 321 and information indicative of a printer detected as a result of a search for printers connected to the same network.

For instance, the OS 313 displays the information indicative of a printer corresponding to the printer information received from the cloud print service 321, with an icon 503 added thereto. Meanwhile, the OS 313 displays the information indicative of a printer detected as a result of a search for printers connected to the same network, with an icon 504 added thereto. The OS 313 can thus discriminatingly display the information indicative of a printer corresponding to the printer information received from the cloud print service 321 and the information indicative of a printer detected as a result of a search for printers connected to the same network. Note that the OS 313 may display only the information indicative of a printer registered to the cloud print service 321, and not display a printer detected as a result of a search for printers connected to the same network.

Next, the user performs a selection operation to select, from the pieces of printer information displayed in the region 502, printer information indicative of the printer that the user wants to register to the client terminal 101.

In S3010, the OS 313 requests the cloud print service 321 for capability information on the printer corresponding to the printer information selected by the user. Note that items in the capability information on the printer that the OS 313 requests in S3010 are ones predetermined based on the specifications of the OS 313 and set in the OS 313.

The OS 313 specifies the set items and requests the cloud print service 321 for capability information covering the set items. The items set in the OS 313 are ones defined by the IPP as standard specifications and are, for example, “paper size,” “paper type,” and “color mode.”

In S3011, in response to the request from the OS 313, the cloud print service 321 transmits capability information on the cloud print-ready printer 104. Note that it is assumed in the present embodiment that the capability information registered to the cloud print service 321 in the registration in S3001 is transmitted to the client terminal 101 in S3011.

Alternatively, the capability information registered to the cloud print service 321 may be transmitted to the client terminal 101 at timing different from the above. For example, the capability information registered to the cloud print service 321 may be transmitted to the client terminal 101 in the event where capability information on the cloud print-ready printer 104 is modified. Also, in the event where a user instructs update of capability information through a user interface provided by the cloud print server 102, capability information updated in response to the instruction may be transmitted to the client terminal 101. Also, the cloud print service 321 may obtain capability information from the cloud print-ready printer 104 at the timing of S3010 and notify the client terminal 101 of the obtained capability information.

In S3011, the cloud print service 321 returns attribute values and default values corresponding to the items requested by the client terminal 101. The attribute values returned here are not limited to the attribute values defined as the industry-standard specifications, but all the attribute values registered to the cloud print service 321. The default values are values set for the printer corresponding to the capability information requested in S3010 by default on a print settings screen displayed on the client terminal 101 by the print app 315. Note that the cloud print service 321 does not respond to the OS 313 in a case where the cloud print service 321 does not hold attribute values and like corresponding to the items requested by the OS 313.

Next, the OS 313 starts installing the cloud printer driver 311 based on the device identification information and the printer name of the printer selected by the user.

In S3012, the OS 313 generates a print que for the cloud printer driver 311 having the basic device capability information packaged with the OS 313. The device capability information in the present embodiment is definition information necessary in generating information indicating the capability of the printer driver used for print settings.

For example, the device capability information indicates information defined in Extensible Markup Language (XML) such as PrintDeviceCapabilities.

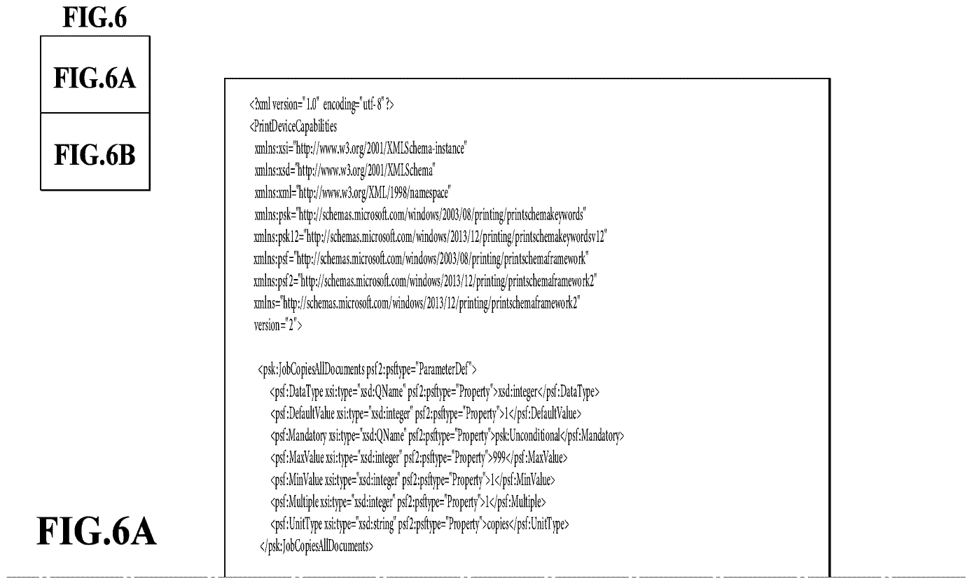

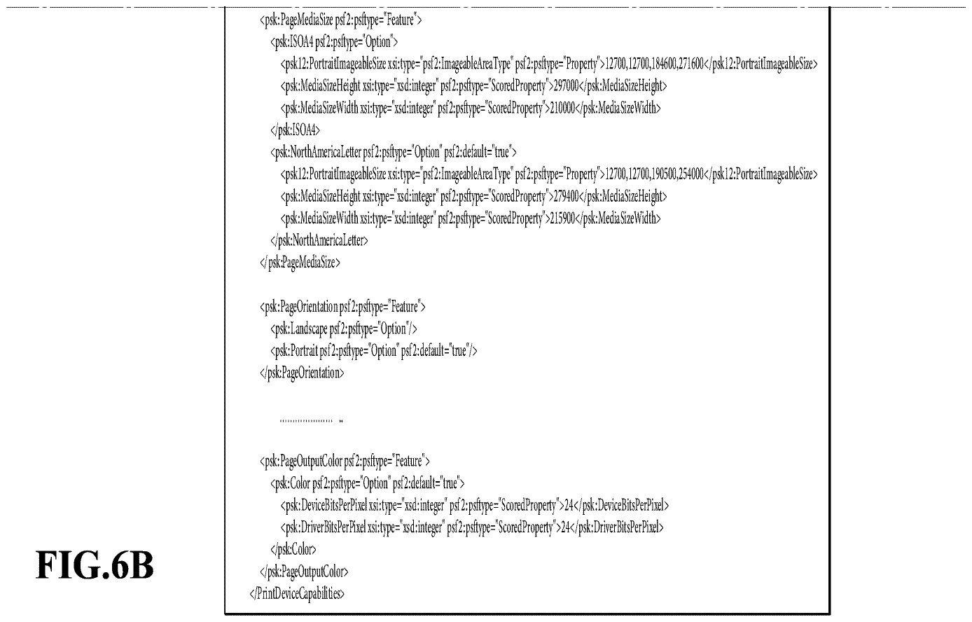

With reference to FIGS. 6 to 8, device capability information in the present embodiment is described. FIGS. 6A and 6B are a diagram showing an example of the basic device capability information packaged with the OS 313. For example, “Feature” indicates that “PageMediaSize” indicative of paper size is a setting item. “Option” indicates an option for “PageMediaSize.” As default values related to paper size, the device capability information contains two options, namely “A4” and “LETTER,” as shown in FIG. 6B. This means that by default, either “A4” or “LETTER” can be set as paper size.

Upon generation of a print que, the device capability information shown in FIGS. 6A and 6B is associated with the print que and stored in the storage and is managed by the OS 313. Note that the basic device capability information is fixed irrespective of the printer connected to the client terminal 101.

After that, using the capability information obtained from the cloud print service 321, the OS 313 updates the device capability information on the cloud printer driver 311.

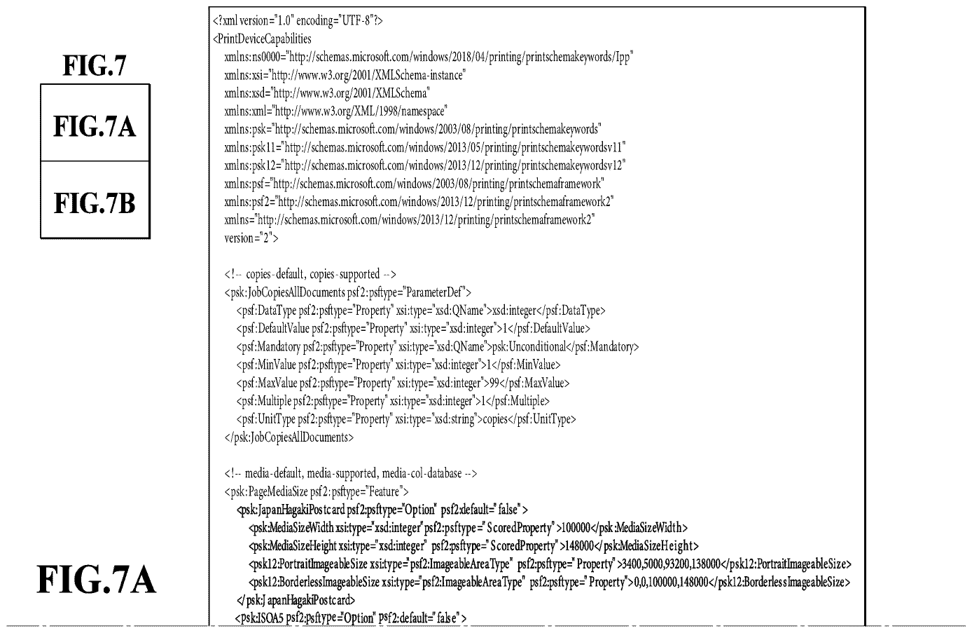

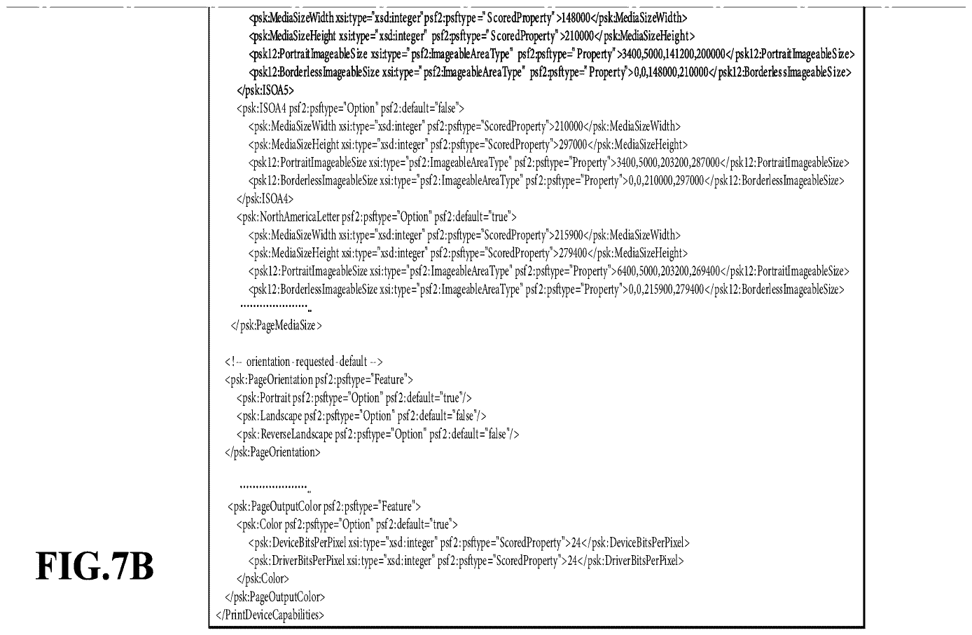

FIGS. 7A and 7B are a diagram showing an example of device capability information updated using the capability information obtained from the cloud print service 321.

For example, concerning “PageMediaSize” indicative of paper size, in comparison to FIG. 6B, the device capability information shown in FIGS. 7A and 7B additionally has items other than “A4” and “LETTER” as “Option” of print size usable in the cloud print-ready printer 104. In this way, first, the OS 313 links the cloud printer driver 311 and the basic device capability information packaged with the OS 313 with each other and registers them to a print que. Then, the OS 313 updates the basic capability information associated with the print que with the capability information obtained from the cloud print service 321. In this event, the OS 313 updates the device capability information using attribute values defined as the industry-standard specifications among the pieces of capability information obtained from the cloud print service 321. Specifically, even in a case of obtaining a vendor-specific attribute value of paper type in S3011, the OS 313 does not add the obtained vendor-specific attribute value as a paper type to the basic device capability information associated with the print que for the registered cloud printer driver 311.

The device information update thus described enables a user to set a print setting value which is unsettable with the basic device capability information packaged with the OS 313.

With this, the installation of the cloud printer driver 311 is completed. Upon completion of the above processing, the client terminal 101 can transmit print data to the print que for the cloud print-ready printer 104 generated in the cloud print service 321.

The OS 313 starts processing to install an application for extending the functionality of the cloud printer driver 311 corresponding to the printer selected by the user in S3010. First, the OS 313 performs processing to add additional information to the device identification information. The application for extending the functionality of the cloud printer driver is hereinafter referred to as a print settings extension app. Also, the processing to add additional information to the device identification information is referred to as additional information addition processing.

The additional information addition processing in the present embodiment is processing that needs to be performed in order for the OS to obtain an extension setup information file 700 to be described later from the online support service 351. The additional information added to the device identification information is any character string different from regular device identification information. In the present embodiment, to distinguish the print settings extension app from applications for other devices, the OS 313 adds additional information (“PrinterApp_”) to the device identification information to indicate that it is an application corresponding to a printer. Note that “PrinterApp_” is an example of the additional information. For example, the additional information may be a different character string, a number, a symbol, or a combination of them.

As a result of the additional information addition processing, in a case where, for example, the device identification information on the cloud print-ready printer 104 is “device001,” device identification information after the additional information addition processing is “PrinterApp_device001.”

In S3013, the OS 313 transmits a request to search for the extension setup information file 700 to the online support service 351, the request including the device identification information obtained by the additional information addition processing. In S3013, the online support service 351 is notified of “PrinterApp_device001” as the device identification information having additional information added thereto.

The online support service 351 holds an extension setup information file shown in FIG. 9. FIG. 9 is a diagram showing an example of the content of the extension setup information file 700. The extension setup information file 700 is a file created and registered to the online support service 351 by the vendor of the cloud print-ready printer 104.

The extension setup information file 700 contains an application identifier for identifying the print settings extension app used to configure settings of print data sent to the cloud print-ready printer 104.

In the content of the extension setup information file shown in FIG. 9, a character string stated under the item “PackageFamilyName” is identification information for identifying the print settings extension app. Also, a character string indicating the device identification information on the cloud print-ready printer 104 including the additional information is stated under “PrinterHardwareID.”

Note that the online support service 351 holds, in addition to the extension setup information file containing the identification information on the print settings extension app, an extension setup information file containing identification information on a printer driver (not shown). The extension setup information file containing identification information on a printer driver contains the identifier of the printer driver under “PackageFamilyName” as the identification information on the printer driver. Also, this extension setup information file contains, under “PrinterHardwareId,” the device identification information on the cloud print-ready printer 104 not including the additional information.

In the present embodiment, the online support service 351 holds both of the extension setup information file containing the identifier of the printer driver and the extension setup information file containing the identifier of the print settings extension app. For this reason, the OS 313 adds additional information to the device identification information in order to obtain a necessary extension setup information file as needed.

Upon receipt of a search request, the online support service 351 detects, from extension setup information files held therein, an extension setup information file containing device identification information matching with the device identification information with additional information specified by the request.

In S3014, if the extension setup information file 700 containing the target device identification information is detected as a result of the search, the online support service 351 transmits the extension setup information file 700 to the OS 313. Upon receipt of the extension setup information file 700 as a response to the search request, the OS 313 writes the content of the received extension setup information file into a registry.

In S3015, the OS 313 installs the extension setup information contained in the extension setup information file 700 obtained from the online support service 351, in association with the print que generated in S3012.

In S3016, the OS 313 extracts the application ID from the extension setup information thus installed. The application ID is, for example, an identifier specified in the extension setup information file under “PackageFamilyName.” The processing described thus far is processing performed in a case where the online support service 351 holds the extension setup information file corresponding to the cloud print-ready printer 104.

There may be a case where the online support service 351 cannot detect the extension setup information file 700 containing the target device identification information as a result of the search. In S3017, the OS 313 completes the installation of the cloud printer driver 311 and terminates the application installation processing. The OS 313 executes the processing in S3017 if the extension setup information file is not received within a predetermined period of time after the search request in S3013 or if an error notification is received from the online support service 351.

Processing in and after S3018 is performed in a case where the extension setup information file was obtained and an application ID was extracted in S3016.

In S3018, the OS 313 requests the application management service 331 to search for an application corresponding to an identifier matching with the extracted application ID. The application management service 331 holds applications that operate in the client terminal 101 and application IDs as the identifiers of the applications, while associating them with each other. The application and the application ID are registered to the application management service 331 by the vendor providing the cloud print-ready printer 104.

In S3019, if a print settings extension app corresponding to an identifier matching with the requested application ID is detected from the applications held therein as a result of the search, the application management service 331 transmits the print settings extension app to the client terminal 101. The print settings extension app that the application management service 331 transmits to the client terminal 101 is an application assigned with the same ID as the application ID transmitted from the client terminal 101.

In S3020, the OS 313 installs the obtained print settings extension app 312 while associating it with the client-side print que. The OS 313 stores the application ID in a registry as information on the print que. Also, the print settings extension app 312 is set in the OS 313 so that an event notification will be made at timing at which the print que associated with the application is set on a print settings screen. The installed print settings extension app 312 is activated after the client terminal 101 is powered on and the OS 313 is activated. Then, the activated print settings extension app 312 runs as a background task.

In S3021, if the application management service 331 cannot detect a print settings extension app corresponding to an identifier matching with the requested application ID, the OS 313 terminates the application installation processing. In this case, the generated print que and the cloud printer driver 311 are associated and installed. Then, the OS 313 terminates the application installation processing without associating the print settings extension app 312 with the print que.

The present embodiment described an example where the online support service 351 searches for an extension setup information file containing the device identification information on the cloud print-ready printer 104, the device identification information including a predetermined character string. Note that in a case where a file for installing a printer driver is distinguishable from other files in the online support service 351, the OS 313 may be configured not to add the predetermined character string to the device identification information.

The present embodiment described an example where the printer selected by the user from the printers presented in the region 502 is a printer registered to the cloud print service 321. Note that a printer detected by the client terminal 101 as a result of searching the network 107 may be selected by the user. In this case, the OS 313 issues the obtainment request for the printer capability information in S3010 to the cloud print-ready printer 104. In S3011, the cloud print-ready printer 104 responds to the OS 313 with the capability information which it holds. Then, in S3012, the OS 313 starts installation of the local printer driver 314 and generates a print que for the local printer driver 314. In S3020, the print settings extension app 312 is installed by the OS 313 in association with the print que for the local printer driver 314.

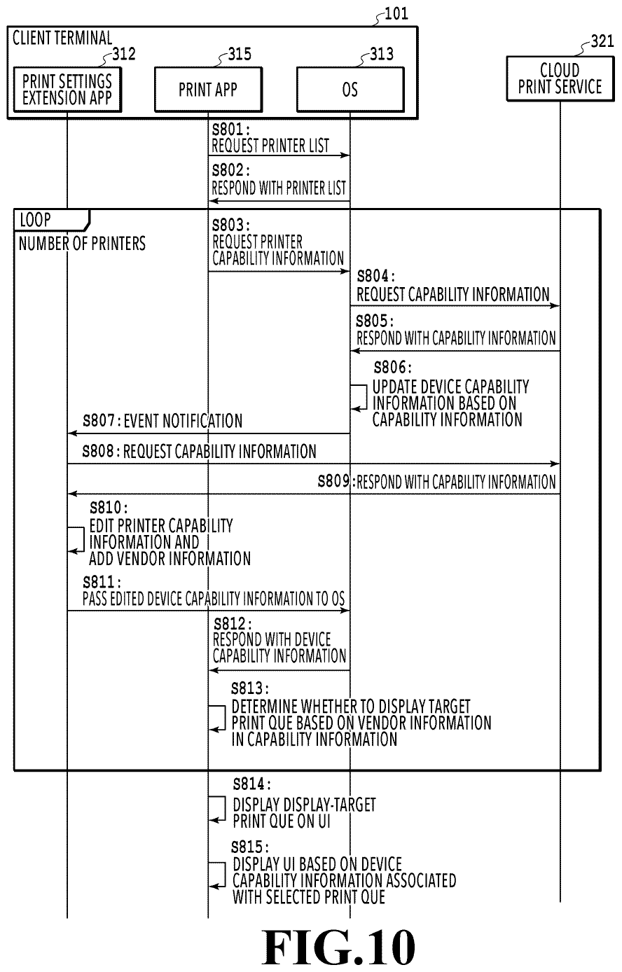

FIG. 10 is a sequence diagram showing an example of display processing where, as a printer for print output, a print application displays a printer provided by a particular vendor. A print application is hereinafter referred to as a print app. With reference to FIG. 10, a description is given of user operations and information processing between the cloud print service 321 and software components of the client terminal 101, performed in order for a print application to display a printer provided by a particular vendor as a printer for print output.

The print app 315 is an application that displays a user interface (UI) that enables configuration of print settings based on capability information on the printer, generates print data in accordance with user operations, and instructs the printer to execute a printing process. Before describing the sequence shown in FIG. 10, the UI of the print app 315 is described.

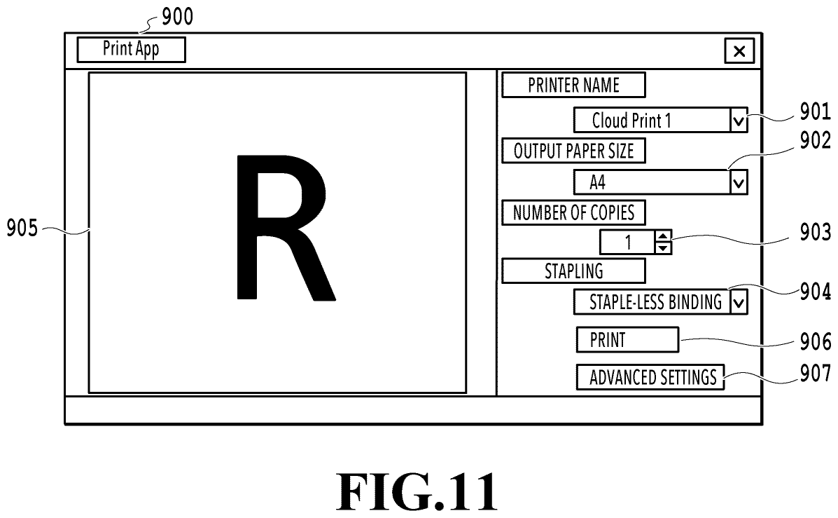

FIG. 11 a diagram showing an example of a UI 900 of the print app 315 after execution of the sequence shown in FIG. 10 and described later. The print app 315 displays the UI 900 shown in FIG. 11 upon receipt of a user operation to open a document file or a user instruction to create a new document.

The display region of the UI 900 displayed by the print app 315 is presented as a window. The UI 900 has a print que selection control 901, an output paper size selection control 902, a number of copies specification control 903, a stapling setting control 904, a preview region 905, a Print button 906, and an Advanced Settings button 907.

The print que selection control 901 is an operator for specifying a print que set as a display target in S813 and S814 (described later) from a list of printer drivers' print ques obtained by the print app 315 in S802 to be described later. In FIG. 11, the print que for the cloud printer driver 311 (or Cloud Print 1 to be specific) is being specified.

The output paper size selection control 902 is an operator that refers to “psk:PageMediaSize” in the device capability information associated with the print que specified on the print que selection control 901 and displays a list of paper sizes. Then, according to the user's paper size selection operation, the output paper size selection control 902 determines the size of a printing medium used for printing in the printer for print output.

The number of copies specification control 903 is an operator for specifying the number of copies. The number of copies specification control 903, like the print que selection control 901, obtains the capability information like the one shown in FIGS. 6A and 6B and displays information indicative of the number of copies obtained.

The stapling setting control 904 is an operator for setting the stapling function. The stapling setting control 904 similarly obtains capability information (not shown) and displays stapling-related information obtained. In FIG. 11, “staple-less binding,” which is a function to bind sheets of paper without metallic staples and is unique to the vendor, is being selected. In this way, the print app 315 is an application that provides a function unique to the vendor of the printer as well.

A preview region 905 is a region displaying a preview of a document file or a print preview. The Print button 906 is a button for receiving an instruction to generate a print job. Once the Print button 906 is pressed by a user, the print app 315 generates a print job and issues, via the OS, a print instruction to the printer driver corresponding to the print que specified in the print que selection control 901.

Although the UI in FIG. 11 displays, e.g., the controls for setting the output paper size, the number of copies, and the stapling function, the controls displayed are not limited to these. As long as the print settings extension app 312 is associated with the print que, a control corresponding to a function stated in the capability information like the one shown in FIGS. 7A and 7B can be displayed. The Advanced Settings button 907 is a button for receiving an instruction to display a settings screen for the printer driver corresponding to the print que specified in the print que selection control 901.

Referring back to FIG. 10, a description is given of display processing where the print app displays a printer provided by a particular vendor as a printer for print output. First, a list of print ques as output targets is displayed as follows. Note that the sequence shown in FIG. 10 starts once the UI of the print app shown in FIG. 11 is displayed. Specifically, the present processing starts once the print app 315 receives an instruction to open a document file or an instruction to create a new document from a user.

In S801, the print app 315, through the printer information obtainment component 3151, requests the OS 313 for a list of print ques.

In S802, in response to the request from the print app 315 in S801, the OS 313 passes information on a list of print ques for printer drivers already installed in the client terminal 101 (hereinafter referred to as a printer list) to the print app 315. Information contained in the printer list includes a printer name, an HWID, and the like as printer information on each printer.

In S803 to S813, the print app 315 determines whether to display, on the print que selection control 901, each of the print ques in the printer list obtained in S802. In S803, the print app 315, through the printer information obtainment component 3151, requests the OS 313 for printer capability information.

In S804, upon receipt of the request from the print app 315 in S803, the OS 313 requests the cloud print service 321 for capability information on the cloud print-ready printer 104 specified in the request.

Note that in the present embodiment, setting items in the capability information requested by the OS 313 in S804 are predetermined based on the specifications of the OS 313. Thus, the capability information requested at this timing is similar to the capability information obtained in S3011 in FIG. 3A. The request that the OS 313 makes in S804 is, for example, issued to the cloud print service 321 using a command of a standard protocol defined by the IPP, like Get-printer-Attributes. In a case of using Get-printer-Attributes, capability information determined by the OS 313 is requested in a list format.

In S805, in response to the request received in S804 using Get-printer-Attributes, the cloud print service 321 transmits, to the OS 313, capability information on the cloud print-ready printer 104 specified in the request. For instance, in a case where a media size attribute is specified by Get-printer-Attributes (IPP), the cloud print service 321, if holding the media size attribute, returns values associated with the attribute (such as A4, B5, and LETTER) to the OS 313.

A case is assumed here in which the print que for the cloud print-ready printer 104 registered to the cloud print service 321 does not have the attribute specified by Get-printer-Attributes. In this case, the cloud print service 321 does not respond to the OS 313 with a value associated with the attribute. The capability information obtained by the OS 313 in S805 is capability information defined as industry-standard specifications and not dependent on the type and capabilities of the printer connected to the client terminal 101.

In the present embodiment, in S805, the cloud print service 321 refers to the capability information on the cloud print-ready printer 104 held in the cloud print service 321 and returns capability information specified by the request received in S804 to the OS 313. Note that, in response to the request in S804, the cloud print service 321 may obtain capability information from the cloud print-ready printer 104 again and respond to the OS 313 by referring to the capability information thus obtained again.

In S806, the OS 313 updates the device capability information using the capability information obtained from the cloud print service 321. The OS 313 adds the capability information obtained in S805 to the device capability information generated in S3012 in FIG. 3B. Note that in the update of the device capability information in S806, attribute values defined as industry-standard specifications are updated in the device capability information.

In S807, the OS 313 notifies the print settings extension app 312 of an event and an API used for editing the device capability information. Timing of event notification is registered at the time of installation of the print settings extension app 312 into the client terminal 101.

Upon receipt of the event from the OS 313, the print settings extension app 312, through the capability information obtainment component 3121, issues an obtainment request for capability information to the cloud print service 321. The capability information that the print settings extension app 312 is to obtain in response to the obtainment request includes setting items and attribute values defined uniquely by the vendor of the printer. In other words, the print settings extension app 312 issues the obtainment request to the cloud print service 321 in order to write the setting items and attribute values defined uniquely by the vendor of the printer into the device capability information.

Upon receipt of the event from the OS 313 in S807, in S808 the print settings extension app 312, through the capability information obtainment component 3121, issues an obtainment request for the capability information on the cloud print-ready printer 104 to the cloud print service 321. The setting items of capability information that the print settings extension app 312 requests from the cloud print service 321 here include setting items unique to the printer vendor and attribute values unique to the printer vendor. The obtainment request in S808 is issued by the print settings extension app 312 using Get-printer-Attributes, similarly to the request in S804. Also, by specifying the item name of a setting item to request, the print settings extension app 312 can obtain capability information associated with the item name.

The present embodiment describes an example where in S808, the print settings extension app 312 issues a capability information obtainment request for setting items including setting items defined uniquely by the printer vendor and attribute values defined uniquely by the printer vendor. Note that in S808, the print settings extension app 312 may also obtain capability information corresponding to the setting items already obtained by the OS 313.

Upon receipt of the capability information obtainment request from the print settings extension app 312, in S809 the cloud print service 321 refers to the capability information on the cloud print-ready printer 104 that it holds. Then, the cloud print service 321 returns the capability information specified in the obtainment request to the print settings extension app 312. How the response is made in S809 is the same as how the response is made in S805 described above.

After obtaining the capability information from the cloud print service 321, the print settings extension app 312, through the capability information update component 3122, edits the device capability information managed by the OS 313 via a configuration information object. A configuration information object in the present embodiment is a collection of data required to edit device capability information. The print settings extension app 312 cannot directly edit the device capability information managed by the OS 313. Thus, a configuration information object is used to modify the device capability information managed by the OS 313.

The print settings extension app 312 can edit the device capability information by converting the capability information unique to the vendor obtained in S809, such as “staple-less binding” and “save job in printer,” into device capability information and adding the device capability information to the configuration information object.

In S810, the print settings extension app 312, through the capability information update component 3122, converts vendor information into device capability information and adds the device capability information to the configuration information object.

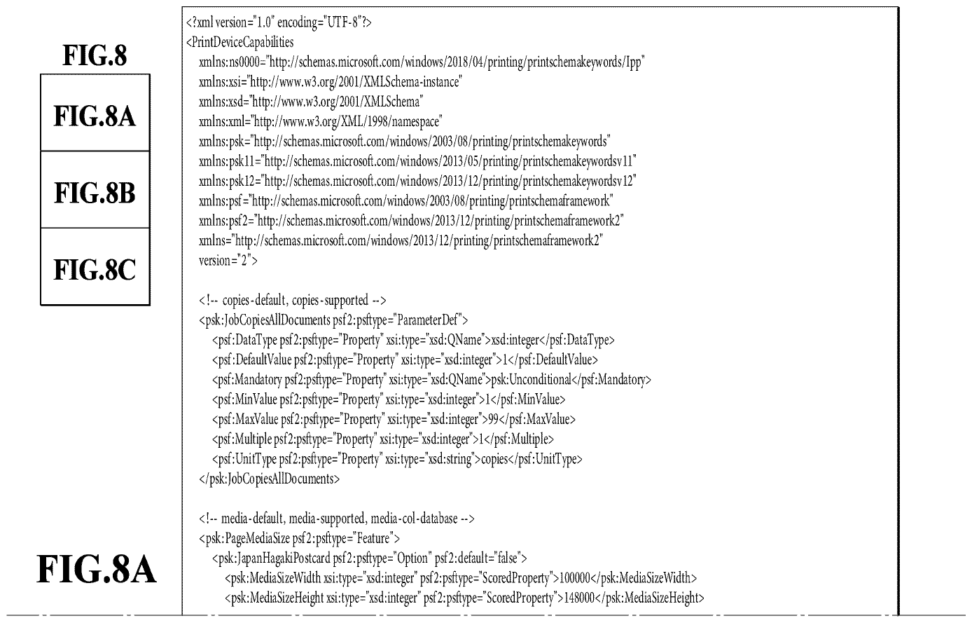

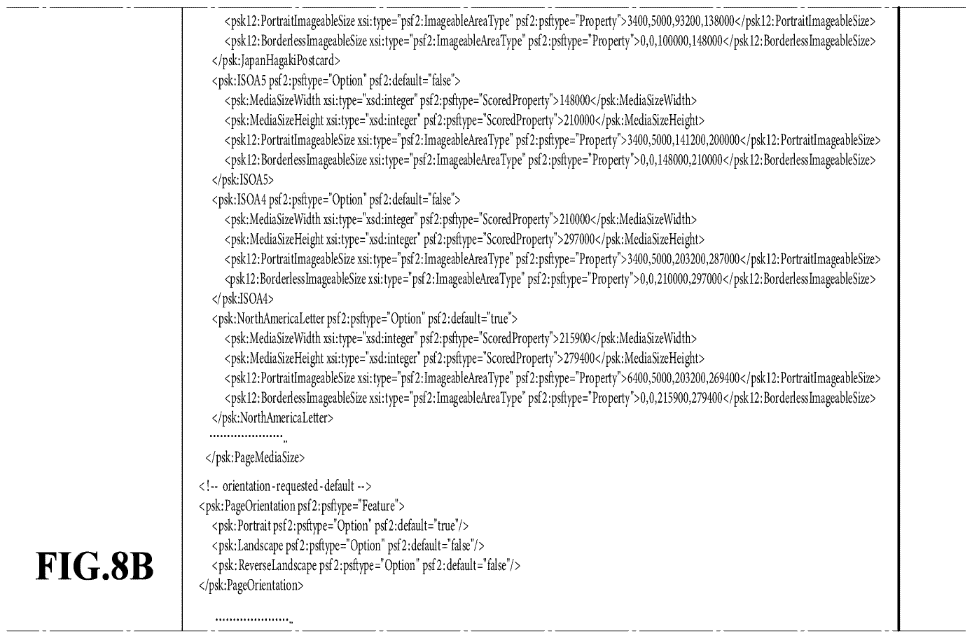

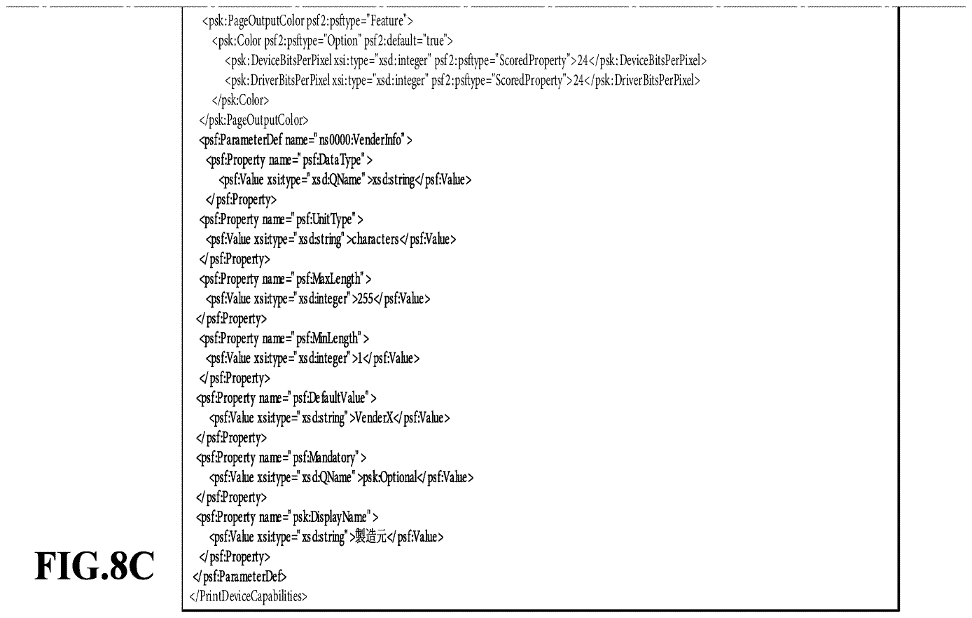

As a result of the processing up to S810, the device capability information has not only the capability information associated with the setting items obtained in response to the request from the OS 313 in S804, but also vendor information included in the setting items and attribute values unique to the vendor of the printer, as shown in FIG. 8C. As shown in FIG. 8C, the vendor information is defined under “VenderInfo.” Also, “VenderX” is stated as “DefaultValue” of “VenderInfo.” This indicates that VenderX is the vendor of the print settings extension app 312. Vendor information indicating the vendor of the print settings extension app 312, which is defined by “VenderInfo,” is referred to in S813 to be described later. Note that in a case where the print settings extension app 312 is registered to the application management service 331 by the vendor providing the cloud print-ready printer 104, the vendor information is information indicative of the vendor providing the cloud print-ready printer 104.

In S811, the print settings extension app 312, through the capability information provision component 3123, passes the edited device capability information to the OS 313. After obtaining the device capability information from the print settings extension app 312, the OS 313 stores the device capability information in the storage while associating it with the print que.

In S812, the OS 313 updates the device capability information based on the device capability information received in S811, and responds to the print app 315 with the updated device capability information.

In S813, the print app 315, through the capability information analysis component 3152, analyzes the vendor information in the device capability information obtained in S812, like the one shown in FIG. 8C. Then, the print app 315, through the capability information analysis component 3152, refers to the analyzed vendor information and determines whether to display, on the print que selection control 901, the print que associated with the device capability information obtained from the OS 313. The print app 315 holds the device capability information obtained from the OS 313 together with the printer name of the printer corresponding to the print que associated with the device capability information.

As a specific example of how to make the determination, the print app 315 determines whether a character string stated under “DefaultValue” of “VenderInfo” as shown in FIG. 8C matches with a character string indicative of a particular vendor. If it is determined that they match, the print app 315 performs control to set the print que which is the current processing target as a display target to be displayed on the print que selection control 901. If it is determined that they do not match, the print app 315 performs control not to set the print que which is the current processing target as a display target to be displayed on the print que selection control 901. Note that the particular vendor may be indicated not only by a single character string, but also by a plurality of character strings.

Once the processing in S803 to S813 is completed for all the print ques in the printer list, in S814 the print app 315 displays the print que set as a display target, on the print que selection control 901. Specifically, as a candidate for an output destination, the print app 315 displays the print que corresponding to the printer of the particular vendor set in S813 as a display target. Specifically, the print que is displayed on the print que selection control 901 in a selectable state.

In S815, in accordance with the device capability information associated with the print que selected on the print que selection control 901, the print app 315 updates presentations of the other controls shown in FIG. 11.

According to the present embodiment, the print settings extension app 312 obtains capability information including vendor information, and thus, the print app 315 can display a printer provided by a particular vendor as a printer for print output.

Although the present embodiment describes the print que for the cloud printer driver 311, the present embodiment can also be applied to a print que for the local printer driver 314. The following describes this case, focusing on differences from the above-described example of the print que for the cloud printer driver 311.

In S804, the OS 313 requests the cloud print-ready printer 104 for the printer's capability information. In response to the request from the OS 313, in S805 the cloud print-ready printer 104 responds to the OS 313 with capability information that it holds. In S808, the print settings extension app 312 requests the cloud print-ready printer 104 for the printer's capability information. In response to the request from the print settings extension app 312, in S809 the cloud print-ready printer 104 responds to the print settings extension app 312 with the capability information.

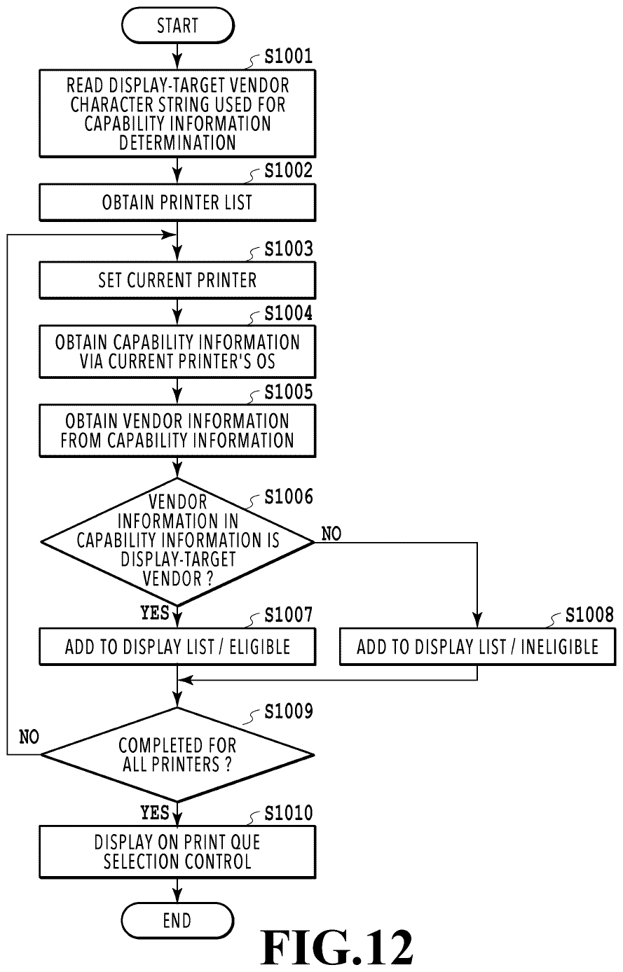

FIG. 12 is a flowchart showing an example of display determination processing in S803 to S813 which is executed by the CPU 212 as a function of the print app 315. With reference to FIG. 12, a description is given of processing where the print app 315 sets and displays a selectable print que on the print que selection control 901.

The processing shown in the flowchart in FIG. 12 is implemented by the CPU 212 of the client terminal 101 by loading a program stored in the storage unit 214 or the like into the memory 213 and executing the loaded program. Note that some or all of the functions in the steps in FIG. 12 may be implemented by hardware such as an ASIC or an electric circuit. The letter “S” used in the description of each processing means that it is a step in the flowchart (this applies to the other flowcharts herein as well).

The process flow shown in FIG. 12 starts once the UI 900 of the print app 315 is displayed. The print app 315 displays the UI 900 upon receipt of an instruction to open a document file or an instruction to create a new document file.

In S1001, the CPU 212, through the capability information analysis component 3152, reads limitation information from a program in the print app 315, an external file, or the like. The limitation information is for limiting a print que to be displayed on the print que selection control 901, and is, for example, formed of a particular character string and used to determine whether to display a print que on the print que selection control 901. The limitation information is hereinafter referred to as a vendor character string. For example, the CPU 212 reads “VenderX” as a vendor character string. Note that the vendor character string may be a plurality of vendor character strings.

In S1002, the CPU 212, through the printer information obtainment component 3151, obtains a list of print ques for printer drivers already installed in the client terminal 101 (hereinafter referred to as a printer list) via the OS 313. The printer list obtained by the print app 315 includes printer names and the like as printer information.

In S1003, the CPU 212, through the printer information obtainment component 3151, takes a printer corresponding to a print que which is included in the printer list obtained in S1002 and for which the display determination has yet to be made and sets this printer as a target of the display determination processing (hereinafter referred to as a current printer).

In S1004, the CPU 212, through the printer information obtainment component 3151, obtains device capability information like the one shown in FIG. 8A to 8C via the OS 313.

In S1005, the CPU 212, through the capability information analysis component 3152, obtains vendor information from the device capability information obtained in S1004 in order to identify the vendor of the current printer. Specifically, in a case where the print settings extension app 312 in the present embodiment is associated with a print que, a character string “VenderX” stated under “DefaultValue” of “VenderInfo” as shown in FIG. 8C is obtained. In contrast, in a case where the print settings extension app 312 is not associated with a print que, the CPU 212 cannot obtain a character string stated under “DefaultValue” of “VenderInfo.” In this case, the CPU 212 obtains information indicative of an empty value instead of vendor information.

In S1006, the CPU 212, through the capability information analysis component 3152, determines whether the vendor character string (“VenderX”) read in S1001 matches with the vendor information obtained from the device capability information in S1005.

If the character string obtained in S1005 and the vendor character string read in S1001 are both, for example, “VenderX,” the CPU 212 determines that the character strings match (YES) and proceeds to S1007. In contrast, if the character string obtained in S1005 is information indicative of an empty value or does not match with the vendor character string read in S1001, the CPU 212 determines that the character strings do not match (NO) and proceeds to S1008.

If the print app 315 has yet to generate a print que display list for managing whether to display a print que in a selectable state on the print que selection control 901 (a list of printer names to display), the CPU 212 generates the display list. Then, the CPU 212 adds the printer name of the current printer obtained in S1002 to the display list.

In S1007, the CPU 212, through the print app 315, associates the printer's name, display eligibility information, and capability information, and stores them in the display list. In this case, the CPU 212 enters and stores “Eligible” as the display eligibility information to indicate that the print que for the current printer is to be displayed on the print que selection control 901. “Table 1” shows an example of the content of the display list held by the print app 315. The display list contains a printer name, display eligibility information, and capability information in association with one another. The capability information shows reference information for referring to device capability information like the ones shown in FIGS. 6 to 8.

TABLE 1

| | Display Eligibility | |
|---|---|---|
| Printer Name | Information | Capability Information |
| Cloud Printer1 | Eligible | Capability Information A |
| Printer XXX | Ineligible | Capability Information B |

In S1008, the CPU 212, through the print app 315, associates and stores, in the display list, the printer's printer name, display eligibility information, and capability information. Unlike S1007, the CPU 212 enters and stores “Ineligible” in the display eligibility information to indicate that the print que for the current printer is not to be displayed on the print que selection control 901.

Note that the method for adding a printer name and the like to the display list is not limited to the method described with S1007 and S1008. For example, the CPU 212 may add, to the display list, a printer name and the like corresponding to a print que to be displayed on the print que selection control 901 and not add, to the display list, a printer name and the like corresponding to a print que not to be displayed. In this case, on the print que selection control 901, the CPU 212 displays the print que corresponding to the printer name added to the display list.

In S1009, the CPU 212, through the capability information analysis component 3152, determines whether the display determination processing to determine whether to display a print que on the print que selection control 901 has been completed for all the print ques contained in the printer list obtained in S1002. If it is determined that the display determination processing has been completed (YES), the CPU 212 proceeds to S1010, and if it is determined that the display determination processing has not been completed (NO), the CPU 212 proceeds to S1003 to continue with the display determination processing to determine whether to display a print que.

In S1010, the CPU 212, through the display control component 3153, sets the display list to the print que selection control 901 to display the print que set as a display target on the print que selection control 901, and ends the present flowchart. For example, the CPU 212 displays, on the print que selection control 901, a print que corresponding to a printer name associated with “Eligible” as the display eligibility information in the display list. Meanwhile, the CPU 212 does not display, on the print que selection control 901, a print que corresponding to a printer name associated with “Ineligible” as the display eligibility information in the display list.

Note that the CPU 212 separately performs display processing for controls and the like included in the UI 900 besides the print que selection control 901. For example, the CPU 212 performs display processing for controls displayed on the UI 900 besides the print que selection control 901 by referring to information contained in the generated display list, like the information shown in “Table 1.”

Assumed here is a case where, in the execution of the present display processing, the client terminal 101 holds print ques for the cloud printer driver 311 and the local printer driver 314 as shown in FIG. 2. In this case, if the print settings extension app 312 having the device capability information like the one in FIG. 8A to 8C is associated with the cloud printer driver 311, a print que for the cloud printer driver 311 is displayed on the print que selection control 901.

### Second Embodiment

The first embodiment describes a flowchart of the display determination processing performed in an example where the client terminal 101 is installed with the cloud printer driver 311 and the local printer driver 314, which are generic printer drivers.

The present embodiment describes display determination processing executed by the CPU 212 as a function of the print app 315 in an example where the client terminal 101 is installed with not only the generic printer drivers, but also a vendor-specific printer driver.

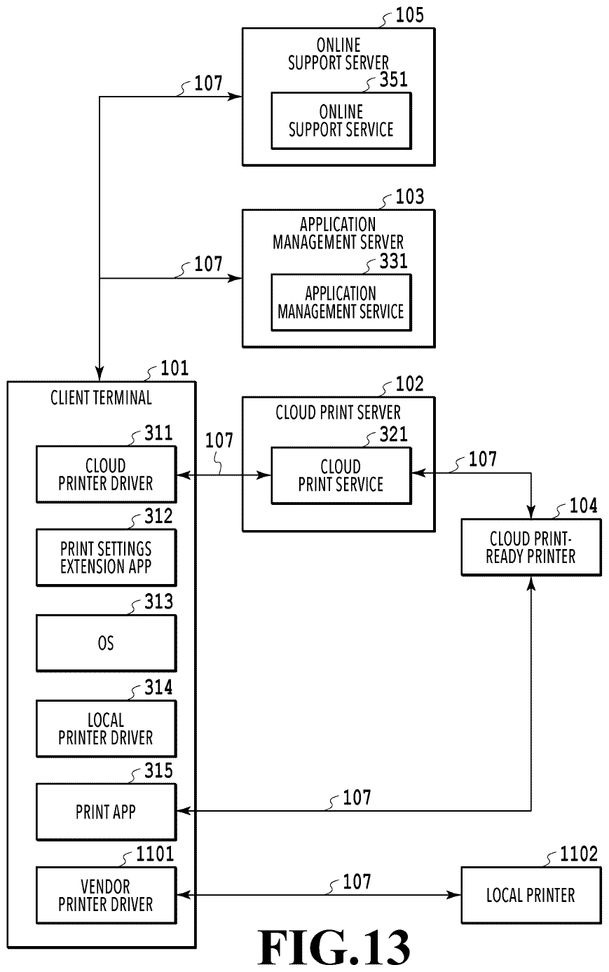

FIG. 13 is a diagram showing an example configuration of a printing system of the present embodiment and an example software configuration of the printing system. The present embodiment differs from the first embodiment in that the client terminal 101 additionally has a vendor printer driver 1101, which is a vendor-specific printer driver. Also, the client terminal 101 in the present embodiment is communicatively connected to a local printer 1102. The local printer 1102 receives print data generated by the vendor printer driver 1101 of the client terminal 101. Note that the other software configurations are similar to those in the first embodiment.

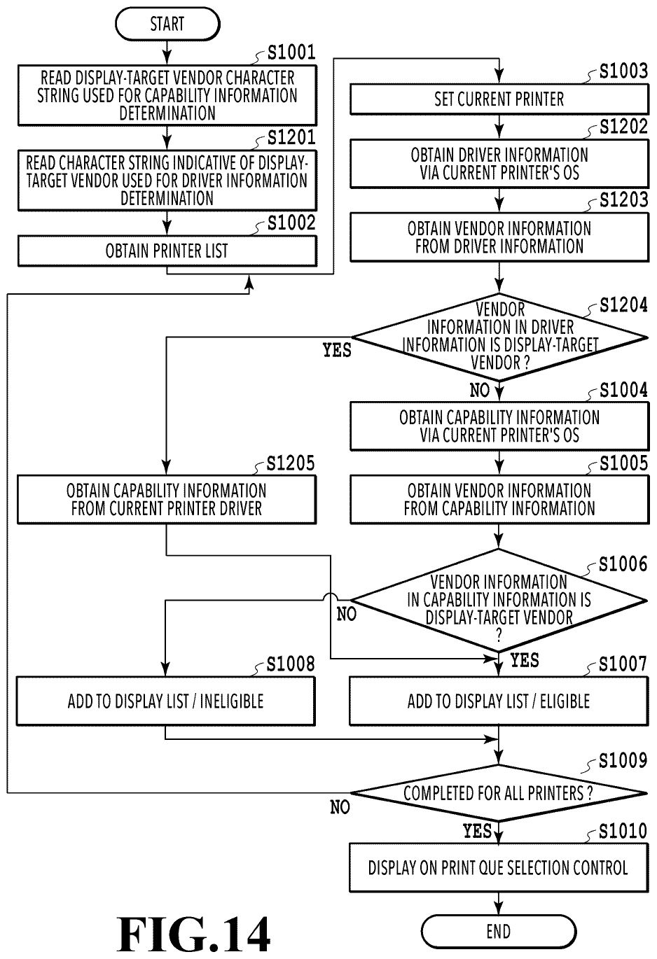

FIG. 14 is a flowchart showing an example of display determination processing executed in the present embodiment by the CPU 212 as a function of the print app 315. With reference to FIG. 14, a description is given of processing where the print app 315 in the present embodiment sets and displays a selectable print que on the print que selection control 901.

Note that similarly with FIG. 12, the process flow shown in FIG. 14 starts once the UI 900 of the print app 315 is displayed. The print app 315 displays the UI 900 upon receipt of an instruction to open a document file or an instruction to create a new document file. Processing steps shown in FIG. 14 which are the same as those in FIG. 12 are denoted by the same reference numerals and are not described.

In S1201, the CPU 212, through the capability information analysis component 3152, reads a character string from a program in the print app 315, an external file, or the like, the character string being indicative of the vendor of a printer driver associated with a display-target print que. The character string read here is used for a comparison with a character string indicative of the vendor of the printer driver included in printer driver information to be described later.

The character string read in S1201 may be the same as the vendor character string read in S1001 or may be a different character string. The present embodiment describes an example where the CPU 212 reads “X” as a character string in S1201. Note that a plurality of character strings may indicate the vendor of the printer driver associated with the display-target print que.

In S1202, the CPU 212, through the printer information obtainment component 3151, obtains printer driver information on the current printer via the OS 313. The printer driver information includes, e.g., character strings indicative of the printer driver's name, version, and vendor.

In S1203, the CPU 212, through the capability information analysis component 3152, obtains a character string indicative of the vendor of the printer driver from the printer driver information obtained in S1202.

In S1204, the CPU 212, through the capability information analysis component 3152, compares the character string read in S1201 and the character string obtained in S1203 indicative of the vendor of the printer driver included in the printer driver information and determines whether they match. In S1204, the CPU 212 determines that they match if the character string indicative of the vendor of the printer driver obtained in S1203 is “X.” In contrast, if the current printer is a printer corresponding to the cloud printer driver 311 or the local printer driver 314, which is a generic printer driver, the character string indicative of the vendor is a character string indicative of the vendor providing the OS 313. In this case, the CPU 212 determines that the character string indicative of the vendor of the printer driver obtained from the printer driver information in S1203 does not match with “X.”

The CPU 212 proceeds to S1205 if the CPU 212, through capability information analysis component 3152, determines in S1204 that the character string indicative of the vendor of the printer driver read in S1201 matches with the character string indicative of the printer driver obtained in S1203 (YES). By contrast, the CPU 212 proceeds to S1004 if it is determined that they do not match (NO). In this case, similarly with the process flow shown in FIG. 12, the CPU 212 determines display eligibility based on the vendor information in the capability information obtained via the OS 313.

In S1205, the CPU 212, through the printer information obtainment component 3151, obtains capability information on the current printer. In S1205, the CPU 212 may obtain the device capability information like the one shown in FIG. 8A to 8C via the OS 313 like in S1004, or may obtain capability information directly from the vendor printer driver 1101 if the printer driver is a vendor-specific one. Regarding the capability information obtained here, like in the first embodiment, a printer name, display eligibility information, and capability information are held in the print app 315 in a format like “Table 1,” and are used for the display processing for the controls 902 to 904 for print settings.

In the present embodiment, in the execution of the process flow shown in FIG. 14, if the client terminal 101 has a print que for a generic printer driver and a print que for the vendor printer driver 1101 of the vendor “X” and if a print que for the cloud printer driver 311 is associated with the print settings extension app having device capability information like the one shown in FIG. 8A to 8C, the print que for the generic printer driver and the print que for the vendor printer driver are allowed to be displayed.

According to the present embodiment, a printer provided by a particular vendor can be displayed as a printer for print output even in an environment where the client terminal 101 is installed with a generic printer driver and a vendor-specific printer driver.

### Third Embodiment

The second embodiment describes an example where a printer provided by a particular vendor is displayed as a printer for print output in an environment where the client terminal is installed with a generic printer driver provided by the vendor of the OS and a vendor-specific printer driver. However, there may be cases where, using a group policy or the like, the OS provides an operation mode where the OS prohibits additional installation of a vendor-specific printer driver or printing using a vendor-specific printer driver. In other words, there may be cases where the OS provides a group policy restricting usage of a vendor-specific printer driver.

In an environment where such a group policy is applied, even if a print que for a vendor-specific printer driver is displayed and selected on the print que selection control 901, a printing process cannot be performed by the printer corresponding to the selected print que.

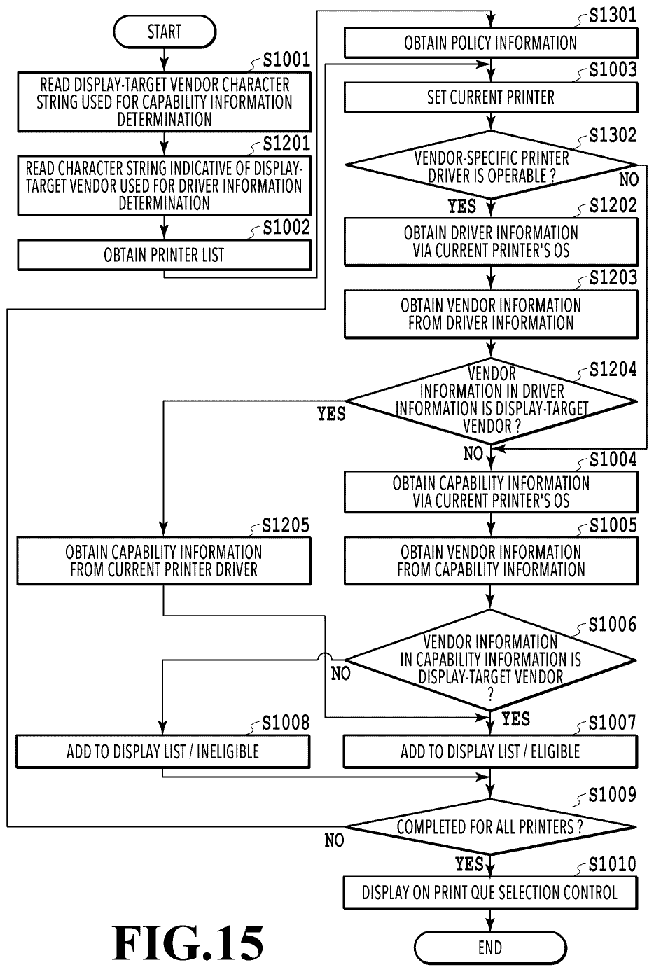

FIG. 15 is a flowchart showing an example of display determination processing executed in the present embodiment by the CPU 212 as a function of the print app 315. With reference to FIG. 15, a description is given of processing where the print app 315 in the third embodiment sets and displays a selectable print que on the print que selection control 901. Note that similarly with FIGS. 12 and 14, the process flow shown in FIG. 15 starts once the UI 900 of the print app 315 is displayed. The print app 315 displays the UI 900 upon receipt of an instruction to open a document file or an instruction to create a new document file.

Processing steps shown in FIG. 15 which are the same as those in FIGS. 12 and 14 are denoted by the same reference numerals and are not described.

In S1301, the CPU 212, through the printer information obtainment component 3151, obtains information on a group policy via the OS 313 and proceeds to S1003. The group policy includes settings on user and computer operations. The group policy also includes operation settings on a printer, a printer driver, and the like. Further, the operation settings include a polity setting on whether to prohibit additional installation of a vendor-specific printer driver and printing using a vendor-specific printer driver.

Based on the group polity obtained in S1301, in S1302 the CPU 212, through the capability information analysis component 3152, determines whether additional installation of a vendor-specific printer driver and printing using such a driver are prohibited.

If it is determined that additional installation of a vendor-specific printer driver and printing using such a driver are prohibited, i.e., if it is determined that a vendor-specific printer driver is inoperable (NO), the CPU 212 proceeds to S1004. In this case, through the steps in and after S1004, the CPU 212 sets a printer corresponding to a print que for a generic printer driver as a determination target and determines whether to add the printer's name and the like to the display list.

If it is determined that additional installation of a vendor-specific printer driver and printing using such a driver are not prohibited, i.e., if it is determined that a vendor-specific printer driver is operable (YES), the CPU 212 proceeds to S1202. In this case, the CPU 212 sets both of a printer corresponding to a print que for a vendor-specific printer driver and a printer corresponding to a print que for a generic printer driver as determination targets and determines whether to add their printer names and the like to the display list.

According to the present embodiment, a print que for a generic printer driver can be properly displayed in a case where an operation mode is applied where additional installation of a vendor-specific printer driver and printing using such a printer driver are prohibited.

### Fourth Embodiment

The first embodiment describes an example where, with the print settings extension app 312 being installed and associated with a print que for a generic printer driver, the print app 315 performs the display determination processing based on vendor information added to device capability information. However, because the print settings extension app 312 is associated with a print que corresponding to a printer which is defined in advance, the print settings extension app 312 is not associated with the print ques for all the generic printer drivers. Thus, in a case where the printer list contains a print que for a generic printer driver with which the print settings extension app 312 is not associated, the print que, even if it is a display target, may fail to be displayed on the print que selection control 901.

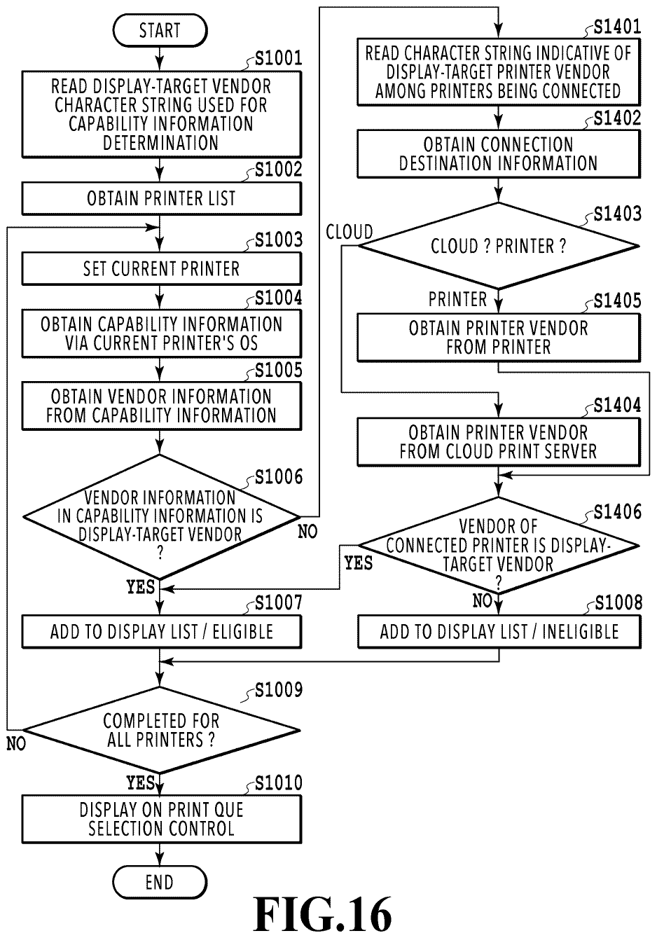

FIG. 16 is a flowchart showing an example of display determination processing executed in the present embodiment by the CPU 212 as a function of the print app 315. With reference to FIG. 16, a description is given of processing where the print app 315 in the present embodiment sets and displays a selectable print que on the print que selection control 901.

Note that similarly with FIG. 12, the process flow shown in FIG. 16 starts once the UI 900 of the print app 315 is displayed. The print app 315 displays the UI 900 upon receipt of an instruction to open a document file or an instruction to create a new document file.

Processing steps shown in FIG. 16 which are the same as those in FIG. 12 are denoted by the same reference numerals and are not described.

The CPU 212 proceeds to S1401 if it is determined in S1006 that the vendor information obtained from the device capability information in S1005 does not match with the vendor character string read in S1001 (NO), and if the vendor information is not obtained.

In S1401, the CPU 212, through the capability information analysis component 3152, reads a character string from a program in the print app 315, an external file, or the like, the character string being indicative of a display-target printer vendor among the printers to which the printer driver is connected. The character string read here may be the same character string as or a different character string from the vendor character string read in S1001.

In S1402, the CPU 212, through the capability information analysis component 3152, obtains connection destination information on a printer to which the printer driver is connected, from the printer.

The connection destination information is information like the one shown in “Table 2.” The connection destination information obtained in S1402 includes, as shown in Table 2, an ID, a printer name, a type, and an URL which are associated with one another and held in the print app 315 in a table format.

“ID” shown in Table 2 is an ID for identifying a printer. In a case where the cloud print-ready printer 104 is registered to the cloud print service 321, the ID is an identifier for identifying the cloud print-ready printer 104. “Printer Name” is the name of a printer. “Type” is a character string indicative of whether the printer driver's connection destination is the cloud print service 321 or the cloud print-ready printer 104. For example, in Table 2, “Type” of the printer named “Cloud Printer 1” is “PrintFAX.Printer.Cloud.” “PrintFAX.Printer.Cloud” indicates that the connection destination is the cloud print service 321. Meanwhile, “Type” of the printer named “Printer XXX” is “PrintFAX.Printer.” “PrintFAX.Printer” indicates that the connection destination is the cloud print-ready printer 104. “URL” indicates the IP address of the connection destination printer. The IP address in Table 2 is used to identify a printer in a case where “Type” is “PrintFAX.Printer” and the printer is directly connected.

TABLE 2

| ID | Printer Name | Type | URL |
|---|---|---|---|
| xxxxx | Cloud Printer 1 | PrintFAX.Printer.Cloud | — |
| — | Printer XXX | PrintFAX.Printer | xxx.xx.xx.x.x |

In 51403, the CPU 212, through the capability information analysis component 3152, determines whether the connection destination of the printer driver corresponding to the current printer is the cloud print service 321 or the cloud print-ready printer 104. The CPU 212 makes this determination by referring to “Type” of the connection destination information obtained in S1402.

The CPU 212 proceeds to S1404 if it is determined that the connection destination of the printer driver corresponding to the current printer is the cloud print service 321, and proceeds to S1405 if it is determined that the connection destination of the printer driver corresponding to the current printer is the cloud print-ready printer 104.

In S1404, the CPU 212, through the print app 315, obtains a character string indicative of the vendor of the current printer from the cloud print service 321. In S1405, through the printer information obtainment component 3151, the CPU 212 obtains a character string indicative of the vendor of the cloud print-ready printer 104 from the cloud print-ready printer 104.

In S1406, the CPU 212, through the capability information analysis component 3152, compares the character string indicative of the display-target printer vendor, which has been read in S1401, with the character string indicative of the vendor of the current printer, which has been obtained in S1404 or S1405. The CPU 212 then determines whether these character strings match.

If it is determined that the character strings match (YES), the CPU 212 proceeds to S1007 to set the print que for the current printer as a display target. In contrast, if it is determined that the character strings do not match (NO), the CPU 212 proceeds to S1008 not to set the print que for the current printer as a display target.

According to the present embodiment, even in a situation where the print settings extension app is not associated with a generic printer driver, if the connected printer is a display-target printer, the print que for the printer can be properly displayed on the print que selection control.

### Other Embodiments

The above embodiments describe examples where, in a case where device capability information and a vendor character string obtained from a printer indicate a particular vendor, the print que for the printer provided by the vendor is displayed on the print que selection control. Note that the print app 315 may perform an operation where functions provided by them are switched between a print que for a printer provided by a particular vendor and other print ques.

For example, all the print ques are displayed on the print que selection control 901 on the UI of the print app 315 shown in FIG. 11. In this case, the output paper size selection control 902 and the number of copies specification control 903, which are standard functions, may be displayed no matter which of the selectable print ques is selected on the print que selection control 901. Meanwhile, irrespective of the capability of the printer, the stapling setting control 904 may be not displayed in a case where a print que for a printer provided by a vendor which is not a specified particular vendor is being selected.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-143490, filed Aug. 23, 2024, which is hereby incorporated by reference herein in its entirety.

What is claimed is:

1. A non-transitory computer-readable storage medium storing a program of a print application for print settings for causing an information processing apparatus to execute a method, the method comprising:
obtaining vendor information on a printing apparatus connected to the information processing apparatus from an extension application which operates in the information processing apparatus and extends functionality of a generic printer driver operating in the information processing apparatus and
performing display control to display the printing apparatus corresponding to the vendor information as a candidate for a printing apparatus for print output.

2. The storage medium according to claim 1, wherein
in the obtaining, limitation information indicative of a predetermined vendor is obtained, the limitation information being for limiting a printing apparatus for print output,
the method further comprises, in a case where the limitation information and the vendor information match, adding the printing apparatus corresponding to the vendor information to a display list holding information on a printing apparatus to be displayed as the candidate in the performing display control, and
in the performing display control, the control to display the printing apparatus corresponding to the vendor information as a candidate for a printing apparatus for print output is performed based on the display list.

3. The storage medium according to claim 2, wherein
in the obtaining, in a case where the limitation information and the vendor information do not match, connection destination information is obtained from the printing apparatus connected to the information processing apparatus, the connection destination information indicating a connection destination of a printer driver corresponding to the printing apparatus, and
in the performing display control, the control to display the printing apparatus corresponding to the vendor information as a candidate for a printing apparatus for print output is performed based on the connection destination information.

4. The storage medium according to claim 1, wherein
in a case where the generic printer driver and a vendor-specific printer driver which corresponds to the printing apparatus connected to the information processing apparatus and is provided by a vendor of the printing apparatus operate in the information processing apparatus, first driver information containing information indicative of a vendor of the generic printer driver or second driver information containing information indicative of a vendor of the vendor-specific printer driver are obtained in the obtaining, and
in the performing display control, the control to display the printing apparatus corresponding to the information indicative of the vendor as a candidate for a printing apparatus for print output is performed based on the first driver information or the second driver information.

5. The storage medium according to claim 4, wherein
in the obtaining, information on a group policy is obtained, the information being provided by an operating system operating in the information processing apparatus and defining a setting on an operation of the vendor-specific printer driver, and
in the performing display control,
in a case where the information on the group policy contains a setting to restrict usage of the vendor-specific printer driver, the printing apparatus corresponding to the vendor-specific printer driver is not set as a display target as the candidate for the printing apparatus for print output, and
in a case where the information on the group policy contains no setting to restrict usage of the vendor-specific printer driver, the printing apparatus corresponding to the vendor-specific printer driver is set as a display target as the candidate for the printing apparatus for print output.

6. The storage medium according to claim 3, wherein
in the obtaining, in a case where the generic printer driver and a vendor-specific printer driver which corresponds to the printing apparatus connected to the information processing apparatus and is provided by a vendor of the printing apparatus operate in the information processing apparatus,
in a case where the connection destination information indicates a cloud print server which is a connection destination of the generic printer driver, information indicative of the vendor of the printing apparatus corresponding to the generic printer driver is obtained from the cloud print server, and
in a case where the connection destination information indicates a local printer which is a connection destination of the vendor-specific printer driver, information indicative of a vendor of the local printer is obtained from the local printer.

7. The storage medium according to claim 1, wherein
in the obtaining, the vendor information is obtained from the extension application as information added to capability information on the printing apparatus.

8. An information processing apparatus configured to execute a print application for print settings, the information processing apparatus comprising:
an obtainment unit configured to obtain vendor information on a printing apparatus connected to the information processing apparatus from an extension application which operates in the information processing apparatus and extends functionality of a generic printer driver operating in the information processing apparatus and
a display control unit configured to perform display control to display the printing apparatus corresponding to the vendor information as a candidate for a printing apparatus for print output.

9. A method for controlling an information processing apparatus implementing a print application for print settings, the method comprising:
obtaining vendor information on a printing apparatus connected to the information processing apparatus from an extension application which operates in the information processing apparatus and extends functionality of a generic printer driver operating in the information processing apparatus and
performing display control to display the printing apparatus corresponding to the vendor information as a candidate for a printing apparatus for print output.
